(19) United States
(12) Patent Application Publication
(10) Pub. No.: US 2026/0080381 A1
(43) Pub. Date: Mar. 19, 2026

(54) Methods and Apparatus for Generating A Contract-Based Transactions Machine

(71) Applicant: Knox Networks, Inc., Palo Alto, CA (US)

(72) Inventors: Satyavrat Purohit, Centreville, VA (US); Mikhail Katychev, Austin, TX (US); Jason Klein, Seabrook, TX (US); Jeremiah Goyette, Austin, TX (US); Francis Kim, Toronto (CA)

(73) Assignee: Knox Networks, Inc., Palo Alto, CA (US)

(21) Appl. No.: 19/281,513

(22) Filed: Jul. 25, 2025

Related U.S. Application Data
(60) Provisional application No. 63/676,293, filed on Jul. 26, 2024.

(51) Int. Cl. G06Q 20/10

(52) U.S. Cl. CPC G06Q 20/10; G06Q 2220/00

(57) ABSTRACT

Provided are methods and apparatus for performing a contract-based transaction of a specified number of assets represented in a digital form. In an example, a computer-implemented method can include (i) receiving, at a computing device and from a contract originator user, information describing: (a) commitments for a contract, where the commitments comprise at least a transfer of a specified number of assets represented in a digital form, (b) conditions for a contract, and (c) an additional participant of the contract; (ii) saving, to a contract proposal data structure, information describing: (a) contract data comprising a universally unique transaction reference, (b) a list of participants by public cryptographic key, and (c) a commitment group comprising an expiration date and one or more commitments; and (iii) electronically sending the contract proposal data structure to the additional participant of the contract, wherein the contract proposal data structure is encrypted using public key cryptography.

### FIELD OF DISCLOSURE

This disclosure relates generally to the technical fields of electronics, computer-readable media, computer engineering, and more specifically, but not exclusively, to methods and apparatus for generating at least a portion of a contract-based transactions machine.

### BACKGROUND

There presently is market demand for computer-implemented contract-based transaction tools. Conventional account-based systems attempt to maintain multiple disjointed ledgers by attempting to keep the disjointed ledgers synchronized over a messaging layer. This makes conventional account-based systems slow and error-prone, forcing use of two-phase commits in an individual system's ledgers. In addition, the account-based systems are not designed to produce auditable trails for every transaction and are not designed to easily interoperate with one another. The account-based systems usually require an add-on system that adds complexity, delay, and error to an overall operation. Further, distributed ledger systems required time-consuming consensus mechanisms and therefore have reduced performance in exchange for security, due to processing bottlenecks. Distributed ledger systems ultimately do not scale from a throughput perspective and from a latency perspective. This problem is particularly impactful during reconciling transactions across different geographic regions.

Accordingly, there are previously unaddressed and long-felt industry needs for methods and apparatus that improve upon conventional methods and conventional apparatus.

### SUMMARY

As is described in greater detail herein, the instant disclosure describes various systems and methods for generating at least a portion of a contract-based transactions machine, performing a contract-based transaction of a specified number of assets represented in a digital form, or both. In examples, the machine can include at least a portion of a contract-based transactions exchange system configured as a set of computer-executable instructions (e.g. software instructions), where the computer-executable instructions can be stored on a suitable non-transitory computer-readable data storage element, a suitable non-transitory computer-readable medium, or both. The provided systems and methods address the previously unaddressed and long-felt industry needs for methods and apparatus that improve upon the conventional methods and the conventional apparatus.

In examples, a computer-implemented method can include (i) receiving, at a computing device and from a contract originator user, information describing (a) commitments for a contract, wherein the commitments include a transfer of the specified number of assets represented in the digital form; (b) conditions for the contract; and (c) an additional participant of the contract (ii) saving, in a computer-readable medium and to a contract proposal data structure, the information describing the commitments for the contract; the conditions for the contract; and the additional participant of the contract; and (iii) electronically sending the contract proposal data structure to the additional participant of the contract.

In an example, provided is a computer-implemented method for performing a contract-based transaction of a specified number of assets represented in a digital form. The method can be performed by a computing device comprising at least one processor. In examples, the method can include: (i) receiving, at the computing device and from a contract originator user, information describing: (a) commitments for a contract, where the commitments include a transfer of the specified number of assets represented in the digital form, (b) conditions for the contract, and (c) an additional participant of the contract; (ii) saving, in a computer-readable medium and to a contract proposal data structure, (a) the information describing the commitments for the contract, (b) the conditions for the contract, and (c) the additional participant of the contract; and (iii) electronically sending the contract proposal data structure to the additional participant of the contract.

In an example, the contract proposal data structure can be encrypted using public key cryptography.

In an example, the method can further include receiving an electronic proposal acknowledgment from the additional participant of the contract, where the electronic proposal acknowledgment indicates the additional participant of the contract confirms receipt of the contract proposal data structure.

In an example, the method can further include (i) saving, in the computer-readable medium and to a contract request data structure, the information describing the commitments for the contract; the conditions for the contract; and the additional participant of the contract; (ii) encrypting the contract request data structure using public key cryptography; and (iii) electronically sending, to the additional participant of the contract, the contract request data structure.

In an example, the method can further include receiving, from the additional participant of the contract, an updated contract request data structure.

In an example, the method can further include (i) receiving an electronic signature of the contract originator user; (ii) saving, in the computer-readable medium and to a contract signatories data structure, the information describing information describing the commitments for the contract; the conditions for the contract, and the additional participant of the contract; (iii) saving the electronic signature of the contract originator user to the contract signatories data structure; and (iv) electronically sending, to the additional participant of the contract, the contract signatories data structure.

In an example, the method can further include receiving, from the additional participant of the contract, an updated contract signatories data structure, where the updated contract signatories data structure includes an electronic signature of the additional participant user and is encrypted using public key cryptography.

In an example, the method can further include electronically sending, to a transaction validator, the updated contract signatories data structure.

In an example, the specified number of assets represented in a digital form can comprise an asset based on a distributed ledger, an asset based on a centralized ledger, or both.

In examples, provided is a system configured to automatically perform a contract-based transaction of a specified number of assets represented in a digital form. The system can include (i) an electronic processor configured to execute a set of computer-executable instructions and (ii) a memory communicatively coupled to the electronic processor and storing the set of computer-executable instructions. The set of computer-executable instructions can be configured to cause the electronic processor to perform at least a portion of a method described herein.

In an example, provided is a system configured to automatically perform a contract-based transaction of a specified number of assets represented in a digital form. The system can include: (i) an electronic processor configured to execute a set of computer-executable instructions and (ii) a memory communicatively coupled to the electronic processor and storing the set of computer-executable instructions. The set of computer-executable instructions can be configured to cause the electronic processor to: (i) receive, at the system and from a contract originator user, information describing: (a) commitments for a contract, where the commitments include a transfer of the specified number of assets represented in the digital form, (b) conditions for the contract, and (c) an additional participant of the contract; (ii) save, in a computer-readable medium and to a contract proposal data structure, (a) the information describing the commitments for the contract, (b) the conditions for the contract, and (c) the additional participant of the contract; and (iii) electronically send the contract proposal data structure to the additional participant of the contract.

In an example, the contract proposal data structure can be encrypted using public key cryptography.

In an example, the memory can further store instructions configured to cause the processor to receive an electronic proposal acknowledgment from the additional participant of the contract, where the electronic proposal acknowledgment indicates the additional participant of the contract confirms receipt of the contract proposal data structure.

In an example, the memory can further store instructions configured to cause the processor to: (i) save, in the computer-readable medium and to a contract request data structure, (a) the information describing the commitments for the contract, (b) the conditions for the contract, and (c) the additional participant of the contract; (ii) encrypt the contract request data structure using public key cryptography; and (iii) electronically send, to the additional participant of the contract, the contract request data structure.

In an example, the memory can further store instructions configured to cause the processor to receive, from the additional participant of the contract, an updated contract request data structure.

In an example, the memory can further store instructions configured to cause the processor to: (i) receive an electronic signature of the contract originator user; (ii) save, in the computer-readable medium and to a contract signatories data structure, (a) the information describing information describing the commitments for the contract, (b) the conditions for the contract, and (c) the additional participant of the contract; (iii) save the electronic signature of the contract originator user to the contract signatories data structure; and (iv) electronically send, to the additional participant of the contract, the contract signatories data structure.

In an example, the memory can further store instructions configured to cause the processor to receive, from the additional participant of the contract, an updated contract signatories data structure, where the updated contract signatories data structure includes an electronic signature of the additional participant user and is encrypted using public key cryptography.

In an example, the memory can further store instructions configured to cause the processor to electronically send, to a transaction validator, the updated contract signatories data structure.

In an example, the specified number of assets represented in a digital form can comprise an asset based on a distributed ledger, an asset based on a centralized ledger, or both.

Embodiments of the disclosed systems and methods are directed to processes and techniques, including at least partially automated processes and at least partially automated techniques, to generate at least a portion of a contract-based transactions machine. In some embodiments, the disclosed systems include computer architecture components that can provide interfaces, code snippets, data structures, and information relationships to enable generating at least a portion of a contract-based transactions machine.

In an embodiment, the disclosure is directed to an apparatus configured to generate at least a portion of a contract-based transactions machine.

The apparatus can include a non-transitory computer-readable medium storing a set of computer-executable instructions and an electronic processor or co-processors. When executed by the electronic processor or co-processors, the instructions cause the electronic processor or co-processors (or a device of which they are part) to perform a set of operations that implement an embodiment of the disclosed methods.

In an embodiment, the disclosure is directed to a non-transitory computer-readable medium storing a set of computer-executable instructions, where the set of instructions can be executed by an electronic processor or co-processors to cause the processor or co-processors (or a device of which the processor or co-processors are a constituent part) to perform a set of operations that implement an embodiment of the disclosed methods.

In an example, provided is a non-transitory computer-readable medium, comprising processor-executable instructions stored thereon configured to cause a processor to: (i) receive, at the system and from a contract originator user, information describing: (a) commitments for a contract, where the commitments include a transfer of the specified number of assets represented in the digital form; (b) conditions for the contract; and (c) an additional participant of the contract; (ii) save, in a computer-readable medium and to a contract proposal data structure, the information describing the commitments for the contract; the conditions for the contract; and the additional participant of the contract; and (iii) electronically send the contract proposal data structure to the additional participant of the contract.

In an example, the contract proposal data structure can be encrypted using public key cryptography.

In an example, the non-transitory computer-readable medium can further include processor-executable instructions stored thereon configured to cause the processor to receive an electronic proposal acknowledgment from the additional participant of the contract, where the electronic proposal acknowledgment indicates the additional participant of the contract confirms receipt of the contract proposal data structure.

In an example, the non-transitory computer-readable medium can further include processor-executable instructions stored thereon configured to cause the processor to: (i) save, in the computer-readable medium and to a contract request data structure, (a) the information describing the commitments for the contract, (b) the conditions for the contract, and (c) the additional participant of the contract; (ii) encrypt the contract request data structure using public key cryptography; and (iii) electronically send, to the additional participant of the contract, the contract request data structure.

In an example, the non-transitory computer-readable medium can further include processor-executable instructions stored thereon configured to cause the processor to receive, from the additional participant of the contract, an updated contract request data structure.

In an example, the non-transitory computer-readable medium can further include processor-executable instructions stored thereon configured to cause the processor to: (i) receive an electronic signature of the contract originator user; (ii) save, in the computer-readable medium and to a contract signatories data structure, the information describing information describing the commitments for the contract; the conditions for the contract, and the additional participant of the contract; (iii) save the electronic signature of the contract originator user to the contract signatories data structure; and (iv) electronically send, to the additional participant of the contract, the contract signatories data structure.

In an example, the non-transitory computer-readable medium can further include processor-executable instructions stored thereon configured to cause the processor to receive, from the additional participant of the contract, an updated contract signatories data structure, where the updated contract signatories data structure includes an electronic signature of the additional participant user and is encrypted using public key cryptography.

In an example, the non-transitory computer-readable medium can further include processor-executable instructions stored thereon configured to cause the processor to electronically send, to a transaction validator, the updated contract signatories data structure.

In an example, provided is a computer-implemented method for performing a contract-based transaction of a specified number of assets represented in a digital form. The method can be performed by a computing device comprising at least one processor. In examples, the method can include: (i) receiving, at the computing device and from a contract originator, a contract proposal data structure; and (ii) displaying, on a user display device, information in the contract proposal data structure, where the information in the contract proposal data structure describes: (a) commitments for a contract, including transfer of the specified number of assets represented in the digital form; and (b) conditions for the contract.

In an example, the information in the contract proposal data structure can further describe a listing of all participants to the contract, and the method can further comprise displaying, on the user display device, at least one participant in the listing of all participants to the contract.

In an example, the contract proposal data structure can be encrypted using public key cryptography, and the method can further include decrypting the contract proposal data structure.

In an example, the method can further include sending, to the contract originator, an electronic proposal acknowledgment, where the electronic proposal acknowledgment confirms receipt of the contract proposal data structure.

In an example, the method can further include (i) receiving, at the computing device and from the contract originator, the contract proposal data structure, where the contract proposal data structure is encrypted using public key cryptography; (ii) decrypting the contract proposal data structure; and (iii) displaying, on a user display device, information in the contract proposal data structure, where the information in the contract proposal data structure describes commitments for a contract and conditions for the contract.

In an example, the method can further include (i) receiving, via a user interface device and from a user who is an additional participant of the contract, an instruction to send an updated contract request data structure; (ii) encrypting the updated contact request data structure using public key cryptography; and (iii) electronically sending, to the contract originator, the updated contract request data structure.

In an example, the method can further include (i) receiving, at the computing device and from the contract originator, a contract signatories data structure, where the contract signatories data structure is encrypted using public key cryptography and comprises an electronic signature of the contract originator user; (ii) decrypting the contract signatories data structure; and (iii) displaying, on a user display device, information in the contract signatories data structure.

In an example, the method can further include (i) receiving, from the user who is an additional participant of the contract, an instruction to send an updated contract signatories data structure; (ii) updating, in response to the instruction to send the updated contract signatories data structure, the contract signatories data structure with an electronic signature of the user who is an additional participant; (iii) encrypting the updated contact signatories data structure using public key cryptography; and (iv) electronically sending, to the contract originator, the updated contract signatories data structure.

In an example, the specified number of assets represented in a digital form can include an asset based on a distributed ledger. In an example, assets represented in a digital form can include an asset based on a distributed ledger.

In an example, the specified number of assets represented in a digital form can include an asset based on a centralized ledger. In an example, the assets represented in a digital form can include an asset based on a centralized ledger. In an example, the specified number of assets represented in a digital form can comprise an asset based on a distributed ledger, an asset based on a centralized ledger, or both.

In an example, the method can further include determining an anti-money laundering condition is met, wherein meeting the anti-money laundering condition is a condition precedent to the exchanging the specified number of assets represented in the digital form identified in the contract.

In an example, the method can further include determining an anti-terrorism financing condition is met, wherein meeting the anti-terrorism financing condition is a condition precedent to the exchanging the specified number of assets represented in the digital form identified in the contract.

In an example, the method can further include determining a sanction condition is met, wherein meeting the sanctions condition is a condition precedent to the exchanging the specified number of assets represented in the digital form identified in the contract.

In an example, the method can further include (i) receiving, via a user interface device and from a user who is an additional participant to the contract, an instruction to reject the contract described by the information in the contract proposal data structure; (ii) receiving, via the user interface device and from the user who is an additional participant to the contract, an electronic signature of the user who is an additional participant to the contract; and (iii) sending, to the contract originator, an electronic message including information describing a rejection of the contract and the electronic signature of the user who is an additional participant to the contract.

In an example, provided is a system configured to automatically perform a contract-based transaction of a specified number of assets represented in a digital form. The system can include: (i) an electronic processor configured to execute a set of computer-executable instructions; (ii) a user display device communicatively coupled to the electronic processor; and (iii) a memory communicatively coupled to the electronic processor and storing the set of computer-executable instructions. The set of computer-executable instructions can be configured to cause the electronic processor to: (a) receive, at the computing device and from a contract originator, a contract proposal data structure; and (b) display, on the user display device, information in the contract proposal data structure, where the information in the contract proposal data structure describes: (I) commitments for a contract, including transfer of the specified number of assets represented in the digital form; and (II) conditions for the contract.

In an example, the information in the contract proposal data structure can further describe a listing of all participants to the contract, and the memory can further store instructions configured to cause the processor to display, on the user display device, at least one participant in the listing of all participants to the contract.

In an example, the contract proposal data structure can be encrypted using public key cryptography, and further comprising decrypting the contract proposal data structure.

In an example, the memory can further store instructions configured to cause the processor to send, to the contract originator, an electronic proposal acknowledgment, where the electronic proposal acknowledgment confirms receipt of the contract proposal data structure.

In an example, the memory can further store instructions configured to cause the processor to: (i) receive, at the computing device and from the contract originator, the contract proposal data structure, where the contract proposal data structure is encrypted using public key cryptography; (ii) decrypt the contract proposal data structure; and (iii) display, on a user display device, information in the contract proposal data structure, where the information in the contract proposal data structure describes commitments for a contract and conditions for the contract.

In an example, the memory can further store instructions configured to cause the processor to: (i) receive, via a user interface device and from a user who is an additional participant of the contract, an instruction to send an updated contract request data structure; (ii) encrypt the updated contact request data structure using public key cryptography; and (iii) electronically send, to the contract originator, the updated contract request data structure.

In an example, the memory can further store instructions configured to cause the processor to: (i) receive, at the computing device and from the contract originator, a contract signatories data structure, where the contract signatories data structure is encrypted using public key cryptography and comprises an electronic signature of the contract originator user; (ii) decrypt the contract signatories data structure; and (iii) display, on a user display device, information in the contract signatories data structure.

In an example, the memory can further store instructions configured to cause the processor to: (i) receive, from the user who is an additional participant of the contract, an instruction to send an updated contract signatories data structure; (ii) update, in response to the instruction to send the updated contract signatories data structure, the contract signatories data structure with an electronic signature of the user who is an additional participant; (iii) encrypt the updated contact signatories data structure using public key cryptography; and (iv) electronically send, to the contract originator, the updated contract signatories data structure.

In an example, the specified number of assets represented in a digital form can comprise an asset based on a distributed ledger, an asset based on a centralized ledger, or both.

In an example, the memory can further store instructions configured to cause the processor to determine an anti-money laundering condition is met, wherein meeting the anti-money laundering condition is a condition precedent to the exchanging the specified number of assets represented in the digital form identified in the contract.

In an example, the memory can further store instructions configured to cause the processor to determine an anti-terrorism financing condition is met, wherein meeting the anti-terrorism financing condition is a condition precedent to the exchanging the specified number of assets represented in the digital form identified in the contract.

In an example, the memory can further store instructions configured to cause the processor to determine a sanction condition is met, wherein meeting the sanctions condition is a condition precedent to the exchanging the specified number of assets represented in the digital form identified in the contract.

In an example, the memory can further store instructions configured to cause the processor to (i) receive, via a user interface device and from a user who is an additional participant to the contract, an instruction to reject the contract described by the information in the contract proposal data structure; (ii) receive, via the user interface device and from the user who is an additional participant to the contract, an electronic signature of the user who is an additional participant to the contract; and (iii) send, to the contract originator, an electronic message including information describing a rejection of the contract and the electronic signature of the user who is an additional participant to the contract.

In an example, provided is a non-transitory computer-readable medium, comprising processor-executable instructions stored thereon configured to cause a processor to: (i) receive, at a computing device and from a contract originator, a contract proposal data structure; and (ii) display, on a user display device, information in the contract proposal data structure, where the information in the contract proposal data structure describes: (a) commitments for a contract, including transfer of the specified number of assets represented in the digital form; and (b) conditions for the contract.

In an example, the information in the contract proposal data structure can further describe a listing of all participants to the contract, and further comprising displaying, on the user display device, at least one participant in the listing of all participants to the contract.

In an example, the contract proposal data structure can be encrypted using public key cryptography, and the non-transitory computer-readable medium can further include processor-executable instructions stored thereon configured to cause the processor to decrypt the contract proposal data structure.

In an example, the non-transitory computer-readable medium can further include processor-executable instructions stored thereon configured to cause the processor to send, to the contract originator, an electronic proposal acknowledgment, where the electronic proposal acknowledgment confirms receipt of the contract proposal data structure.

In an example, the non-transitory computer-readable medium can further include processor-executable instructions stored thereon configured to cause the processor to: (i) receive, at the computing device and from the contract originator, the contract proposal data structure, where the contract proposal data structure is encrypted using public key cryptography; (ii) decrypt the contract proposal data structure; and (iii) display, on a user display device, information in the contract proposal data structure, where the information in the contract proposal data structure describes commitments for a contract and conditions for the contract.

In an example, the non-transitory computer-readable medium can further include processor-executable instructions stored thereon configured to cause the processor to: (i) receive, via a user interface device and from a user who is an additional participant of the contract, an instruction to send an updated contract request data structure; (ii) encrypt the updated contact request data structure using public key cryptography; and (iii) electronically send, to the contract originator, the updated contract request data structure.

In an example, the non-transitory computer-readable medium can further include processor-executable instructions stored thereon configured to cause the processor to: (i) receive, at the computing device and from the contract originator, a contract signatories data structure, where the contract signatories data structure is encrypted using public key cryptography and comprises an electronic signature of the contract originator user; (ii) decrypt the contract signatories data structure; and (iii) display, on a user display device, information in the contract signatories data structure.

In an example, the non-transitory computer-readable medium can further include processor-executable instructions stored thereon configured to cause the processor to: (i) receive, from the user who is an additional participant of the contract, an instruction to send an updated contract signatories data structure; (ii) update, in response to the instruction to send the updated contract signatories data structure, the contract signatories data structure with an electronic signature of the user who is an additional participant; (iii) encrypt the updated contact signatories data structure using public key cryptography; and (iv) electronically send, to the contract originator, the updated contract signatories data structure.

In an example, the specified number of assets represented in a digital form can comprise an asset based on a distributed ledger, an asset based on a centralized ledger, or both.

In an example, the non-transitory computer-readable medium can further include processor-executable instructions stored thereon configured to cause the processor to determine an anti-money laundering condition is met, wherein meeting the anti-money laundering condition is a condition precedent to the exchanging the specified number of assets represented in the digital form identified in the contract.

In an example, the non-transitory computer-readable medium can further include processor-executable instructions stored thereon configured to cause the processor to determine an anti-terrorism financing condition is met, wherein meeting the anti-terrorism financing condition is a condition precedent to the exchanging the specified number of assets represented in the digital form identified in the contract.

In an example, the non-transitory computer-readable medium can further include processor-executable instructions stored thereon configured to cause the processor to determine a sanction condition is met, wherein meeting the sanctions condition is a condition precedent to the exchanging the specified number of assets represented in the digital form identified in the contract.

In an example, the non-transitory computer-readable medium can further include processor-executable instructions stored thereon configured to cause the processor to (i) receive, via a user interface device and from a user who is an additional participant to the contract, an instruction to reject the contract described by the information in the contract proposal data structure; (ii) receive, via the user interface device and from the user who is an additional participant to the contract, an electronic signature of the user who is an additional participant to the contract; and (iii) send, to the contract originator, an electronic message including information describing a rejection of the contract and the electronic signature of the user who is an additional participant to the contract.

In an example, provided is a computer-implemented method for performing a contract-based transaction of a specified number of assets represented in a digital form. The method can be performed by a computing device comprising at least one processor. In examples, the method can include: (i) receiving, at the computing device and from a contract originator, a signed contract signatories data structure that includes: (a) information describing: (I) commitments for a contract, where the commitments include a transfer of the specified number of assets represented in the digital form, (II) conditions for the contract, and (III) an additional participant of the contract; and (b) digital signatures of all participants in the contract; and (ii) sending, to at least one of the contract originator or the additional participant of the contract, information confirming receipt of the contract.

In an example, the signed contract signatories data structure can be encrypted using public key cryptography.

In an example, the method can further include decrypting the signed contract signatories data structure.

In an example, the method can further include (i) receiving, at the computing device, information confirming fulfillment of a contract commitment of the contract originator, (ii) receiving, at the computing device, information confirming fulfillment of a contract commitment of the additional participant of the contract, (iii) determining all conditions of the contract are completed, (iv) appending a digital signature of a transaction validator to the specified number of assets represented in the digital form identified in the contract, and (v) exchanging the specified number of assets represented in the digital form in response to: (a) the receiving the information describing the fulfillment of the contract commitment of the contract originator, (b) the receiving the information describing the fulfillment of the contract commitment of the additional participant of the contract, and (c) the determining all conditions of the contract are completed.

In an example, the method can further include checking for double spending by at least one of the contract originator or the additional participant of the contract, where an absence of double spending is a condition precedent to the exchanging the specified number of assets represented in the digital form identified in the contract.

In an example, the method can further include determining a time deadline has not passed, where meeting the time deadline is a condition precedent to the exchanging the specified number of assets represented in the digital form identified in the contract.

In an example, the method can further include determining an anti-money laundering condition is met, where meeting the anti-money laundering condition is a condition precedent to the exchanging the specified number of assets represented in the digital form identified in the contract.

In an example, the method can further include determining an anti-terrorism financing condition is met, where meeting the anti-terrorism financing condition is a condition precedent to the exchanging the specified number of assets represented in the digital form identified in the contract.

In an example, the method can further include determining a sanction condition is met, where meeting the sanctions condition is a condition precedent to the exchanging the specified number of assets represented in the digital form identified in the contract.

In an example, the method can further include determining an address validation condition is met, where meeting the address validation condition is a condition precedent to the exchanging the specified number of assets represented in the digital form identified in the contract.

In an example, the specified number of assets represented in a digital form can comprise an asset based on a distributed ledger, an asset based on a centralized ledger, or both.

In an example, provided is a system configured to automatically perform a contract-based transaction of a specified number of assets represented in a digital form. The system can include: (i) an electronic processor configured to execute a set of computer-executable instructions; and (ii) a memory communicatively coupled to the electronic processor and storing the set of computer-executable instructions. The set of computer-executable instructions can be configured to cause the electronic processor to: (i) receive, at the computing device and from a contract originator, a signed contract signatories data structure that includes: (a) information describing: (I) commitments for a contract, where the commitments include a transfer of the specified number of assets represented in the digital form, (II) conditions for the contract, and (III) an additional participant of the contract, and (b) digital signatures of all participants in the contract, and (ii) send, to at least one of the contract originator or the additional participant of the contract, information confirming receipt of the contract.

In an example, the signed contract signatories data structure can be encrypted using public key cryptography.

In an example, the memory can further store instructions configured to cause the processor to decrypt the signed contract signatories data structure.

In an example, the memory can further store instructions configured to cause the processor to: (i) receive, at the computing device, information confirming fulfillment of a contract commitment of the contract originator, (ii) receive, at the computing device, information confirming fulfillment of a contract commitment of the additional participant of the contract, (iii) determine all conditions of the contract are completed, (iv) append a digital signature of a transaction validator to the specified number of assets represented in the digital form identified in the contract, and (v) exchange the specified number of assets represented in the digital form in response to: (a) the receiving the information describing the fulfillment of the contract commitment of the contract originator, (b) the receiving the information describing the fulfillment of the contract commitment of the additional participant of the contract, and (c) the determining all conditions of the contract are completed.

In an example, the memory can further store instructions configured to cause the processor to check for double spending by at least one of the contract originator or the additional participant of the contract, where an absence of double spending is a condition precedent to the exchanging the specified number of assets represented in the digital form identified in the contract.

In an example, the memory can further store instructions configured to cause the processor to determine a time deadline has not passed, where meeting the time deadline is a condition precedent to the exchanging the specified number of assets represented in the digital form identified in the contract.

In an example, the memory can further store instructions configured to cause the processor to determine an anti-money laundering condition is met, where meeting the anti-money laundering condition is a condition precedent to the exchanging the specified number of assets represented in the digital form identified in the contract.

In an example, the memory can further store instructions configured to cause the processor to determine an anti-terrorism financing condition is met, where meeting the anti-terrorism financing condition is a condition precedent to the exchanging the specified number of assets represented in the digital form identified in the contract.

In an example, the memory can further store instructions configured to cause the processor to determine a sanction condition is met, where meeting the sanctions condition is a condition precedent to the exchanging the specified number of assets represented in the digital form identified in the contract.

In an example, the memory can further store instructions configured to cause the processor to determine an address validation condition is met, where meeting the address validation condition is a condition precedent to the exchanging the specified number of assets represented in the digital form identified in the contract.

In an example, the specified number of assets represented in a digital form can include an asset based on a distributed ledger. In an example, assets represented in a digital form can include an asset based on a distributed ledger.

In an example, the specified number of assets represented in a digital form can include an asset based on a centralized ledger. In an example, the assets represented in a digital form can include an asset based on a centralized ledger.

In an example, provided is a non-transitory computer-readable medium, comprising processor-executable instructions stored thereon configured to cause a processor to: (i) receive, at a computing device and from a contract originator, a signed contract signatories data structure that includes: (a) information describing: (I) commitments for a contract, where the commitments include a transfer of the specified number of assets represented in the digital form, (II) conditions for the contract, and (III) an additional participant of the contract, and (b) digital signatures of all participants in the contract, and (ii) send, to at least one of the contract originator or the additional participant of the contract, information confirming receipt of the contract.

In an example, the signed contract signatories data structure can be encrypted using public key cryptography.

In an example, the non-transitory computer-readable medium can further include processor-executable instructions stored thereon configured to cause the processor to decrypt the signed contract signatories data structure.

In an example, the non-transitory computer-readable medium can further include processor-executable instructions stored thereon configured to cause the processor to: (i) receive, at the computing device, information confirming fulfillment of a contract commitment of the contract originator, (ii) receive, at the computing device, information confirming fulfillment of a contract commitment of the additional participant of the contract, (iii) determine all conditions of the contract are completed, (iv) append a digital signature of a transaction validator to the specified number of assets represented in the digital form identified in the contract, and (v) exchange the specified number of assets represented in the digital form in response to: (a) the receiving the information describing the fulfillment of the contract commitment of the contract originator, (b) the receiving the information describing the fulfillment of the contract commitment of the additional participant of the contract, and (c) the determining all conditions of the contract are completed.

In an example, the non-transitory computer-readable medium can further include processor-executable instructions stored thereon configured to cause the processor to check for double spending by at least one of the contract originator or the additional participant of the contract, where an absence of double spending is a condition precedent to the exchanging the specified number of assets represented in the digital form identified in the contract.

In an example, the non-transitory computer-readable medium can further include processor-executable instructions stored thereon configured to cause the processor to determine a time deadline has not passed, where meeting the time deadline is a condition precedent to the exchanging the specified number of assets represented in the digital form identified in the contract.

In an example, the non-transitory computer-readable medium can further include processor-executable instructions stored thereon configured to cause the processor to determine an anti-money laundering condition is met, where meeting the anti-money laundering condition is a condition precedent to the exchanging the specified number of assets represented in the digital form identified in the contract.

In an example, the non-transitory computer-readable medium can further include processor-executable instructions stored thereon configured to cause the processor to determine an anti-terrorism financing condition is met, where meeting the anti-terrorism financing condition is a condition precedent to the exchanging the specified number of assets represented in the digital form identified in the contract.

In an example, the non-transitory computer-readable medium can further include processor-executable instructions stored thereon configured to cause the processor to determine a sanction condition is met, where meeting the sanctions condition is a condition precedent to the exchanging the specified number of assets represented in the digital form identified in the contract.

In an example, the non-transitory computer-readable medium can further include processor-executable instructions stored thereon configured to cause the processor to determine an address validation condition is met, where meeting the address validation condition is a condition precedent to the exchanging the specified number of assets represented in the digital form identified in the contract.

In an example, the specified number of assets represented in a digital form can include an asset based on a distributed ledger. In an example, assets represented in a digital form can include an asset based on a distributed ledger.

In an example, the specified number of assets represented in a digital form can include an asset based on a centralized ledger. In an example, the assets represented in a digital form can include an asset based on a centralized ledger.

In an example, provided is a computer-implemented method for performing a contract-based transaction of a specified number of assets represented in a digital form. The method can be performed by a computing device comprising at least one processor. In examples, the method can include: (i) receiving, at the computing device and from a contract originator user, information describing: (a) commitments for a contract, where the commitments comprise at least a transfer of the specified number of assets represented in the digital form, (b) conditions for the contract, and (c) an additional participant of the contract; (ii) saving, in a computer-readable medium and to a contract proposal data structure, information describing: (a) contract data comprising a start date, a memo field configured to store miscellaneous information and metadata, a contract type, a universally unique transaction reference, and a retry interval for retrying in a non-success scenario, (b) a list of participants by public cryptographic key, and (c) a commitment group comprising an expiration date and one or more commitments, each commitment comprising: (I) an amount, (II) at least one sender key corresponding to at least one respective participant, and (III) at least one respective recipient key corresponding to at least one respective participant, and (iii) electronically sending the contract proposal data structure to the additional participant of the contract, where the contract proposal data structure is encrypted using public key cryptography.

In an example, the method can further include receiving an electronic proposal acknowledgment from the additional participant of the contract. The electronic proposal acknowledgment can indicate the additional participant of the contract confirms receipt of the contract proposal data structure.

In an example, the method can further include (i) saving, in the computer-readable medium and to a contract request data structure, the information describing the commitments for the contract; the conditions for the contract; and the additional participant of the contract; (ii) encrypting the contract request data structure using public key cryptography; and (iii) electronically sending, to the additional participant of the contract, the contract request data structure.

In an example, the method can further include receiving, from the additional participant of the contract, an updated contract request data structure.

In an example, the method can further include (i) receiving an electronic signature of the contract originator user; (ii) saving, in the computer-readable medium and to a contract signatories data structure, the information describing the commitments for the contract; the conditions for the contract; and the additional participant of the contract; (iii) saving the electronic signature of the contract originator user to the contract signatories data structure; and (iv) electronically sending, to the additional participant of the contract, the contract signatories data structure.

In an example, the method can further include receiving, from the additional participant of the contract, an updated contract signatories data structure. The updated contract signatories data structure can include an electronic signature of an additional participant user. The updated contract signatories data structure can be encrypted using public key cryptography.

In an example, the method can further include electronically sending, to a transaction validator, an updated contract signatories data structure.

In an example, the specified number of assets represented in a digital form can include an asset based on a distributed ledger, an asset based on a centralized ledger, or both.

In an example, the information in the contract proposal data structure can further describe a listing of all participants to the contract. The method can further include displaying, on a user display device, at least one participant in the listing of all participants to the contract.

In an example, the method can further include sending, to the contract originator, an electronic proposal acknowledgment. The electronic proposal acknowledgment can confirm receipt of the contract proposal data structure.

In an example, the method can further include (i) receiving, at another computing device and from the contract originator, the contract proposal data structure; (ii) decrypting the contract proposal data structure; and (iii) displaying, on a user display device, information in the contract proposal data structure. The information in the contract proposal data structure can describe the commitments for a contract, the conditions for the contract, or both.

In an example, the method can further include (i) receiving, via a user interface device and from a user who is an additional participant of the contract, an instruction to send an updated contract request data structure; (ii) encrypting the updated contract request data structure using public key cryptography; and (iii) electronically sending, to the contract originator, the updated contract request data structure.

In an example, the method can further include (i) receiving, at another computing device and from the contract originator, a contract signatories data structure, where the contract signatories data structure is encrypted using public key cryptography and includes an electronic signature of the contract originator user; (ii) decrypting the contract signatories data structure; and (iii) displaying, on a user display device, information in the contract signatories data structure.

In an example, the method can further include (i) receiving, from a user who is an additional participant of the contract, an instruction to send an updated contract signatories data structure; (ii) updating, in response to the instruction to send the updated contract signatories data structure, the contract signatories data structure with an electronic signature of the user who is the additional participant; (iii) encrypting the updated contract signatories data structure using public key cryptography; and (iv) electronically sending, to the contract originator, the updated contract signatories data structure.

In an example, the method can further include determining that a condition requiring an absence of unlawful activity is met. The meeting the condition requiring the absence of the unlawful activity can be a condition precedent to exchanging the specified number of assets represented in the digital form identified in the contract.

In an example, the method can further include (i) receiving, at another computing device and from the contract originator, the contract proposal data structure; and (ii) displaying, on a user display device, information in the contract proposal data structure, where the information in the contract proposal data structure describes: (a) the commitments for the contract, including transfer of the specified number of assets represented in the digital form, (b) the conditions for the contract, or (c) both.

In an example, the method can further include decrypting the contract proposal data structure.

In an example, the method can further include: (i) receiving, via a user interface device and from a user who is an additional participant to the contract, an instruction to reject the contract described by the information in the contract proposal data structure; (ii) receiving, via the user interface device and from the user who is an additional participant to the contract, an electronic signature of the user who is an additional participant to the contract; and (iii) sending, to the contract originator, an electronic message including information describing a rejection of the contract and the electronic signature of the user who is an additional participant to the contract.

In an example, provided is a system configured to automatically perform a contract-based transaction of a specified number of assets represented in a digital form. The system can include: (i) an electronic processor configured to execute a set of computer-executable instructions and (ii) a memory communicatively coupled to the electronic processor and storing the set of computer-executable instructions. The set of computer-executable instructions can be configured to cause the electronic processor to: (i) receive, at the computing device and from a contract originator user, information describing: (a) commitments for a contract, where the commitments comprise at least a transfer of the specified number of assets represented in the digital form, (b) conditions for the contract, and (c) an additional participant of the contract; (ii) save, in a computer-readable medium and to a contract proposal data structure, information describing: (a) contract data comprising a start date, a memo field configured to store miscellaneous information and metadata, a contract type, a universally unique transaction reference, and a retry interval for retrying in a non-success scenario, (b) a list of participants by public cryptographic key, and (c) a commitment group comprising an expiration date and one or more commitments, each commitment comprising: (I) an amount, (II) at least one sender key corresponding to at least one respective participant, and (III) at least one respective recipient key corresponding to at least one respective participant, and (iii) electronically send the contract proposal data structure to the additional participant of the contract, where the contract proposal data structure is encrypted using public key cryptography.

In an example, the memory can further store instructions configured to cause the processor to receive an electronic proposal acknowledgment from the additional participant of the contract. The electronic proposal acknowledgment can indicate the additional participant of the contract confirms receipt of the contract proposal data structure.

In an example, the memory can further store instructions configured to cause the processor to (i) save, in the computer-readable medium and to a contract request data structure, the information describing the commitments for the contract; the conditions for the contract; and the additional participant of the contract; (ii) encrypt the contract request data structure using public key cryptography; and (iii) electronically send, to the additional participant of the contract, the contract request data structure.

In an example, the memory can further store instructions configured to cause the processor to receive, from the additional participant of the contract, an updated contract request data structure.

In an example, the memory can further store instructions configured to cause the processor to (i) receive an electronic signature of the contract originator user; (ii) save, in the computer-readable medium and to a contract signatories data structure, the information describing the commitments for the contract; the conditions for the contract; and the additional participant of the contract; (iii) save the electronic signature of the contract originator user to the contract signatories data structure; and (iv) electronically send, to the additional participant of the contract, the contract signatories data structure.

In an example, the memory can further store instructions configured to cause the processor to receive, from the additional participant of the contract, an updated contract signatories data structure. The updated contract signatories data structure can include an electronic signature of an additional participant user. The updated contract signatories data structure can be encrypted using public key cryptography.

In an example, the memory can further store instructions configured to cause the processor to electronically send, to a transaction validator, an updated contract signatories data structure.

In an example, the specified number of assets represented in a digital form can include an asset based on a distributed ledger, an asset based on a centralized ledger, or both.

In an example, the information in the contract proposal data structure can further describe a listing of all participants to the contract. The memory can further store instructions configured to cause the processor to display, on a user display device, at least one participant in the listing of all participants to the contract.

In an example, the memory can further store instructions configured to cause the processor to send, to the contract originator, an electronic proposal acknowledgment. The electronic proposal acknowledgment can confirm receipt of the contract proposal data structure.

In an example, the memory can further store instructions configured to cause the processor to (i) receive, at another computing device and from the contract originator, the contract proposal data structure; (ii) decrypt the contract proposal data structure; and (iii) display, on a user display device, information in the contract proposal data structure. The information in the contract proposal data structure can describe the commitments for a contract, the conditions for the contract, or both.

In an example, the memory can further store instructions configured to cause the processor to (i) receive, via a user interface device and from a user who is an additional participant of the contract, an instruction to send an updated contract request data structure; (ii) encrypt the updated contract request data structure using public key cryptography; and (iii) electronically send, to the contract originator, the updated contract request data structure.

In an example, the memory can further store instructions configured to cause the processor to (i) receive, at another computing device and from the contract originator, a contract signatories data structure, where the contract signatories data structure is encrypted using public key cryptography and includes an electronic signature of the contract originator user; (ii) decrypt the contract signatories data structure; and (iii) display, on a user display device, information in the contract signatories data structure.

In an example, the memory can further store instructions configured to cause the processor to (i) receive, from a user who is an additional participant of the contract, an instruction to send an updated contract signatories data structure; (ii) update, in response to the instruction to send the updated contract signatories data structure, the contract signatories data structure with an electronic signature of the user who is the additional participant; (iii) encrypt the updated contract signatories data structure using public key cryptography; and (iv) electronically send, to the contract originator, the updated contract signatories data structure.

In an example, the memory can further store instructions configured to cause the processor to determine that a condition requiring an absence of unlawful activity is met. The meeting the condition requiring the absence of the unlawful activity can be a condition precedent to exchanging the specified number of assets represented in the digital form identified in the contract.

In an example, the memory can further store instructions configured to cause the processor to (i) receive, at another computing device and from the contract originator, the contract proposal data structure; and (ii) display, on a user display device, information in the contract proposal data structure, where the information in the contract proposal data structure describes: (a) the commitments for the contract, including transfer of the specified number of assets represented in the digital form, (b) the conditions for the contract, or (c) both.

In an example, the memory can further store instructions configured to cause the processor to decrypt the contract proposal data structure.

In an example, the memory can further store instructions configured to cause the processor to: (i) receive, via a user interface device and from a user who is an additional participant to the contract, an instruction to reject the contract described by the information in the contract proposal data structure; (ii) receive, via the user interface device and from the user who is an additional participant to the contract, an electronic signature of the user who is an additional participant to the contract; and (iii) send, to the contract originator, an electronic message including information describing a rejection of the contract and the electronic signature of the user who is an additional participant to the contract.

In an example, provided is a non-transitory computer-readable medium, comprising processor-executable instructions stored thereon configured to cause a processor to perform a contract-based transaction of a specified number of assets represented in a digital form, the instructions comprising: (i) instructions to receive, at the computing device and from a contract originator user, information describing: (a) commitments for a contract, where the commitments comprise at least a transfer of the specified number of assets represented in the digital form, (b) conditions for the contract, and (c) an additional participant of the contract; (ii) instructions to save, in a computer-readable medium and to a contract proposal data structure, information describing: (a) contract data comprising a start date, a memo field configured to store miscellaneous information and metadata, a contract type, a universally unique transaction reference, and a retry interval for retrying in a non-success scenario, (b) a list of participants by public cryptographic key, and (c) a commitment group comprising an expiration date and one or more commitments, each commitment comprising: (I) an amount, (II) at least one sender key corresponding to at least one respective participant, and (III) at least one respective recipient key corresponding to at least one respective participant, and (iii) instructions to electronically send the contract proposal data structure to the additional participant of the contract, where the contract proposal data structure is encrypted using public key cryptography.

In an example, the non-transitory computer-readable medium can further include processor-executable instructions stored thereon configured to cause the processor to receive an electronic proposal acknowledgment from the additional participant of the contract. The electronic proposal acknowledgment can indicate the additional participant of the contract confirms receipt of the contract proposal data structure.

In an example, the non-transitory computer-readable medium can further include processor-executable instructions stored thereon configured to cause the processor to (i) save, in the computer-readable medium and to a contract request data structure, the information describing the commitments for the contract; the conditions for the contract; and the additional participant of the contract; (ii) encrypt the contract request data structure using public key cryptography; and (iii) electronically send, to the additional participant of the contract, the contract request data structure.

In an example, the non-transitory computer-readable medium can further include processor-executable instructions stored thereon configured to cause the processor to receive, from the additional participant of the contract, an updated contract request data structure.

In an example, the non-transitory computer-readable medium can further include processor-executable instructions stored thereon configured to cause the processor to (i) receive an electronic signature of the contract originator user; (ii) save, in the computer-readable medium and to a contract signatories data structure, the information describing the commitments for the contract; the conditions for the contract; and the additional participant of the contract; (iii) save the electronic signature of the contract originator user to the contract signatories data structure; and (iv) electronically send, to the additional participant of the contract, the contract signatories data structure.

In an example, the non-transitory computer-readable medium can further include processor-executable instructions stored thereon configured to cause the processor to receive, from the additional participant of the contract, an updated contract signatories data structure. The updated contract signatories data structure can include an electronic signature of an additional participant user. The updated contract signatories data structure can be encrypted using public key cryptography.

In an example, the non-transitory computer-readable medium can further include processor-executable instructions stored thereon configured to cause the processor to electronically send, to a transaction validator, an updated contract signatories data structure.

In an example, the specified number of assets represented in a digital form can include an asset based on a distributed ledger, an asset based on a centralized ledger, or both.

In an example, the information in the contract proposal data structure can further describe a listing of all participants to the contract. The non-transitory computer-readable medium can further include processor-executable instructions stored thereon configured to cause the processor to display, on a user display device, at least one participant in the listing of all participants to the contract.

In an example, the non-transitory computer-readable medium can further include processor-executable instructions stored thereon configured to cause the processor to send, to the contract originator, an electronic proposal acknowledgment. The electronic proposal acknowledgment can confirm receipt of the contract proposal data structure.

In an example, the non-transitory computer-readable medium can further include processor-executable instructions stored thereon configured to cause the processor to (i) receive, at another computing device and from the contract originator, the contract proposal data structure; (ii) decrypt the contract proposal data structure; and (iii) display, on a user display device, information in the contract proposal data structure. The information in the contract proposal data structure can describe the commitments for a contract, the conditions for the contract, or both.

In an example, the non-transitory computer-readable medium can further include processor-executable instructions stored thereon configured to cause the processor to (i) receive, via a user interface device and from a user who is an additional participant of the contract, an instruction to send an updated contract request data structure; (ii) encrypt the updated contract request data structure using public key cryptography; and (iii) electronically send, to the contract originator, the updated contract request data structure.

In an example, the non-transitory computer-readable medium can further include processor-executable instructions stored thereon configured to cause the processor to (i) receive, at another computing device and from the contract originator, a contract signatories data structure, where the contract signatories data structure is encrypted using public key cryptography and includes an electronic signature of the contract originator user; (ii) decrypt the contract signatories data structure; and (iii) display, on a user display device, information in the contract signatories data structure.

In an example, the non-transitory computer-readable medium can further include processor-executable instructions stored thereon configured to cause the processor to (i) receive, from a user who is an additional participant of the contract, an instruction to send an updated contract signatories data structure; (ii) update, in response to the instruction to send the updated contract signatories data structure, the contract signatories data structure with an electronic signature of the user who is the additional participant; (iii) encrypt the updated contract signatories data structure using public key cryptography; and (iv) electronically send, to the contract originator, the updated contract signatories data structure.

In an example, the non-transitory computer-readable medium can further include processor-executable instructions stored thereon configured to cause the processor to determine that a condition requiring an absence of unlawful activity is met. The meeting the condition requiring the absence of the unlawful activity can be a condition precedent to exchanging the specified number of assets represented in the digital form identified in the contract.

In an example, the non-transitory computer-readable medium can further include processor-executable instructions stored thereon configured to cause the processor to (i) receive, at another computing device and from the contract originator, the contract proposal data structure; and (ii) display, on a user display device, information in the contract proposal data structure, where the information in the contract proposal data structure describes: (a) the commitments for the contract, including transfer of the specified number of assets represented in the digital form, (b) the conditions for the contract, or (c) both.

In an example, the non-transitory computer-readable medium can further include processor-executable instructions stored thereon configured to cause the processor to decrypt the contract proposal data structure.

In an example, the non-transitory computer-readable medium can further include processor-executable instructions stored thereon configured to cause the processor to: (i) receive, via a user interface device and from a user who is an additional participant to the contract, an instruction to reject the contract described by the information in the contract proposal data structure; (ii) receive, via the user interface device and from the user who is an additional participant to the contract, an electronic signature of the user who is an additional participant to the contract; and (iii) send, to the contract originator, an electronic message including information describing a rejection of the contract and the electronic signature of the user who is an additional participant to the contract.

In some embodiments, the systems and methods disclosed herein can provide services through a software as a service (Saas), a multi-tenant platform, or a combination thereof. The multi-tenant platform can provide access to multiple entities (e.g. tenants), each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods or functions disclosed herein.

The terms “invention,” “the invention,” “this invention,” “the present invention,” “the present disclosure,” or “the disclosure” as used herein are intended to refer broadly to all subject matter disclosed in this document, the drawings (i.e. the Figures), and the claims. Statements containing these terms do not limit the subject matter disclosed or the meaning or scope of the claims. Embodiments covered by this disclosure are defined by the claims and not by this summary. This summary is a high-level overview of various examples and aspects of the disclosure and introduces some concepts that are further described in detail hereby. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

Advantages of the provided systems, apparatuses, and methods will be apparent to one of ordinary skill in the art upon review of the detailed description and the included Figures. While the exemplary embodiments provided hereby are susceptible to various modifications and alternative forms, specific embodiments are shown by way of example in the drawings and are described in detail herein. However, the exemplary or specific embodiments are not intended to be limited to the forms described. Rather, the disclosure covers all modifications, equivalents, and alternatives falling within the scope of the appended claims.

### BRIEF DESCRIPTION OF THE DRAWINGS

The accompanying drawings are presented to describe examples of the present teachings and are not limiting. Together with this following description, the drawings demonstrate and explain various principles of the present disclosure.

Embodiments of the disclosure are described with reference to the drawings, in which:

FIG. 1A depicts an example block diagram of an example method for performing, by a contract originator machine, a contract-based transaction of a specified number of assets represented in a digital form, in accordance with an embodiment of the disclosure.

FIG. 1B depicts an example block diagram of an example method for performing, by an additional participant machine, a contract-based transaction of a specified number of assets represented in a digital form, in accordance with an embodiment of the disclosure.

FIG. 1C depicts an example block diagram of an example method for performing, by a transaction validator machine, a contract-based transaction of a specified number of assets represented in a digital form, in accordance with an embodiment of the disclosure.

FIG. 1D depicts an example block diagram of an example method for performing, by a machine, a contract-based transaction of a specified number of assets represented in a digital form, in accordance with an embodiment of the disclosure.

FIG. 2A depicts an example network implementation of a system suitable for implementing examples of the disclosed subject matter.

FIG. 2B depicts an example diagram of an example computing device suitable for implementing examples of the disclosed subject matter.

FIG. 3 depicts a non-limiting example method for performing, by a contract originator machine and an additional participant machine, a contract-based transaction of a specified number of assets represented in a digital form, in accordance with an embodiment of the disclosure.

FIG. 4 depicts an example contract negotiation message payload of an electronic contract proposal message, in accordance with an embodiment of the disclosure.

FIG. 5 depicts an example contract negotiation message payload of an electronic first contract request message, in accordance with an embodiment of the disclosure.

FIG. 6 depicts an example contract negotiation message payload of an electronic second contract request message, in accordance with an embodiment of the disclosure.

FIG. 7 depicts an example contract negotiation message payload of an electronic first contract signatories message, in accordance with an embodiment of the disclosure.

FIG. 8 depicts an example contract negotiation message payload of an electronic second contract request message, in accordance with an embodiment of the disclosure.

FIG. 9 is a diagram depicting a non-limiting example user interface including a user display or portion thereof with an example of a page of a graphical user interface of a contract-based transactions machine, in accordance with an embodiment of the disclosure.

FIG. 10 depicts an example entity relationship diagram for contract, commitment, and participant data structures, in accordance with an embodiment of the disclosure.

Each of the drawings is provided for illustration and description only and does not limit the present disclosure. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Provided are example methods and apparatuses that can be used to automatically generate at least a portion of a contract-based transactions machine, perform a contract-based transaction of a specified number of assets represented in a digital form, or both.

The provided methods and apparatus configured to perform Contract-Based Transactions introduce controlled programmability into payments. The provided methods and apparatus separate the programmability layer (contract negotiation) from the asset transfer layer (contract fulfillment) within a Transaction Validator Service. A Contract-Based Transaction can fulfill a transfer of assets that is stipulated in a successfully negotiated contract.

A contract can include a set of commitments made between participants in the contract together with conditions applicable (e.g. a timeout condition). A contract can feature one or more commitments and zero or more conditions. In some examples, a commitment can be a participant's agreement to transfer a specified amount of an asset type to another participant (e.g. Alice agrees to pay Bob $100). The originator broadcasts, using the apparatus described herein, the contract (including all proposed commitments) to all participants in a contract, including those participants that solely receive assets. In some examples, a condition can be a check to determine if a contract should continue. In some examples, checks can include time checks, balance checks, more complicated conditions such as information provided via Oracles, or combination thereof. Contracts can create modular transactions that cover a wide range of use cases, including atomic multi-party and multi-asset settlements (PvP, DvP), cross border payments, escrow, etc., and support industry recognized techniques such as Hashed Timelock Contracts (HTLCs). Hashed time lot contracts can implement a transaction methodology that reduces counterparty risk by using half blocks and time locks to force acknowledgment of payment and/or forfeit or payment, thereby allowing for atomicity in multi-step transactions.

In examples, the provided methods and apparatus can apply commitments and conditions that are cryptographically verifiable. In examples, public-key cryptography standards (PKCS) algorithms (such as ED25519) can be used in the signing and verification phase of contract creation and execution.

In some examples, the provided methods and apparatus can perform a contract-based transaction in phases: (i) a proposal phase, (ii) a negotiation phase, (iii) a confirmation phase, and (iv) an asset transfer phase.

In the proposal phase, a contract can be proposed by an originator who proposes a set of commitments and conditions to be fulfilled by participants to the contract. In an example, a contract can include a condition that certain predetermined assets (e.g. assets in a margin account) are automatically forfeited by a party to the contract if the party's commitments to the contract are not met. A party placing a certain quantity of assets in the margin account (e.g. by a predetermined time) can be a condition the contract. In some embodiments, some commitments by a party can be conditioned on other conditions not being met.

In the negotiation phase, any participant can decide to accept or reject a proposed contract based upon their own criteria. If all participants except the proposed contract, confirmation of intended commitments from all participants can be obtained. All participants can digitally sign the contract as proof of agreement and acceptance.

Alternatively, a participant can propose a new contract that is a modified version of the previously proposed contract. Any participant in a contract negotiation can be entitled to amend a contract and counter-propose an alternative set of commitments and conditions. This technique provides a rejection of the prior contract, a cessation of the prior contract process, and assigns the role of “originator” to the participant that amended the contract. Thus, the prior contract negotiation terminates without success and a new contract negotiation begins.

In the confirmation phase, digitally signed confirmations are received from all participants of the contract. Each participant electronically submits the required assets corresponding to their commitments, which are then locked so the same assets cannot be double spent. The originator can inform a transaction manager (e.g. a transaction validator) of existence of a finalized contract (i.e. a contract that is ratified by all participants and for which all assets to be transferred have been submitted). The transaction validator, in response, can confirm (e.g. validate) all conditions in the contract have been met.

In the asset transfer phase, the participants transfer assets corresponding to the respective commitment. In an example, assets can be locked via a notary. The transaction validator can determine if all contract commitments are fulfilled and all contract conditions are met. If participants do not submit their assets by a condition specified in the contract (e.g. a timeout condition), the system atomically reverts ownership of previously locked assets to the original owners. Examples of other conditions besides timeouts can include anti-money laundering checks, combating the financing of terrorism checks, sanctions checks, valid address checks, etc.

in an example, the contract proposal can include a timeout condition. The timeout condition can cause a contract to automatically become abandoned after a predetermined period of time in response to an absence of a response from a counterparty (e.g. from an additional participant machine, from a contract originator machine, etc.). The predetermined period of time can commence when the contract originator machine sends an electronic contract proposal message. In some examples, the timeout condition can cause the contract to automatically come abandoned a certain time. In some examples, a timeout condition can require that all commitments must be met by a predetermined period of time or a specific time. In examples, when the timeout condition causes the contract automatically to become abandoned, ownership of all assets identified in the contract revert to their original owners.

If all contract commitments are fulfilled and all contract conditions are met, then the transaction validator can order a notary to atomically unlock and exchange the assets described in the contract. The participants can then retrieve exchanged assets.

The provided methods and apparatus can enable describing a contract in terms of commitments between participants, together with applicable conditions. The provided methods and apparatus can enable (i) one participant constructing the contract and broadcasting it to all participants for their confirmation, (ii) participants confirming the contract by adding their digital signatures as verifiable proof of willingness to participate in the contract OR alternatively participants indicating unwillingness by rejecting the contract proposal, (iii) collecting confirmations with signatures such that a successfully negotiated contract can then be published to a separate adjudicating entity that is not one of the participants itself, (iv) broadcasting information describing the successfully negotiated contract to all participants in two the adjudicating entity, (v) the invention providing non reputability of a participant's willingness to participate in the contract, (vi) allowing all participants to inspect and validate their respective obligations under the contract before they provide confirmation, (vii) each participant to know the identity of all participants to the contract, (viii) all participants to know that all other participants have agreed to the contract in addition to themselves, (ix) providing a stronger assurance, relative to conventional techniques, of the commitments under the contract of being likely to be fulfilled before any participant commences fulfilment of their own commitments, (x) or a combination thereof.

The provided methods and apparatus can enable an adjudicating party that is also responsible for finalizing asset transfers to reason about a state of fulfillment of commitments, since the exact commitments have been conveyed to the adjudicating party in advance.

The provided methods and apparatus can enable creating contracts between an arbitrary number of participants and involving arbitrary asset types.

The provided systems and methods provide many advantages.

The provided methods and apparatus configured to perform Contract-Based Transactions can advantageously improve upon conventional techniques and systems by reducing costly errors, limiting exposure to counterparty failures, and enforcing compliance by allowing institutions to stipulate regulatory requirements before any transfer of assets takes place. All assets can be transferred atomically: if any participant fails to deliver on any of their commitments, then all assets retain their original owner.

The provided methods and apparatus configured to perform Contract-Based Transactions can advantageously offer several improvements over Smart Contracts with a specific applicability to transactions in regulated financial instruments.

The provided methods and apparatus configured to perform Contract-Based Transactions can advantageously cater to the needs of regulated financial system by allowing all participants to apply validation rules, including regulatory checks, before agreeing to be a participant in the contract.

The provided methods and apparatus configured to perform Contract-Based Transactions can advantageously require no particular participant address for execution of a contract. Thus, any arbitrary set of participants at any address can be participants.

The provided methods and apparatus configured to perform Contract-Based Transactions can advantageously provide a materialized form of each contract that can be stored, inspected and understood easily.

The provided methods and apparatus configured to perform Contract-Based Transactions can advantageously provide easy construction of a contract involving an arbitrary number of participants and types of assets as and when needed. For example, the provided methods and apparatus can be used to create transactions of the types (i) payment-vs-payment and (ii) delivery-vs-payment involving an arbitrary number of participants, such as would be required in a cross-border delivery-vs-payment across multiple participants.

The provided methods and apparatus configured to perform Contract-Based Transactions can advantageously separate a contract negotiation from an asset transfer, thus allowing all participants to be assured of all other participants'confirmation before performing any asset transfers, which can help participants avoid expensive errors and corrective actions.

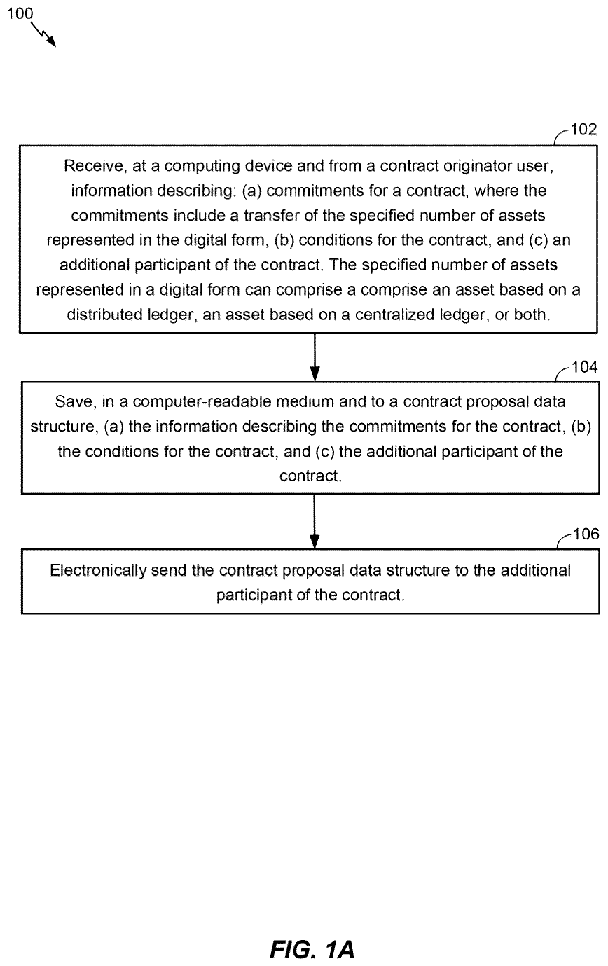

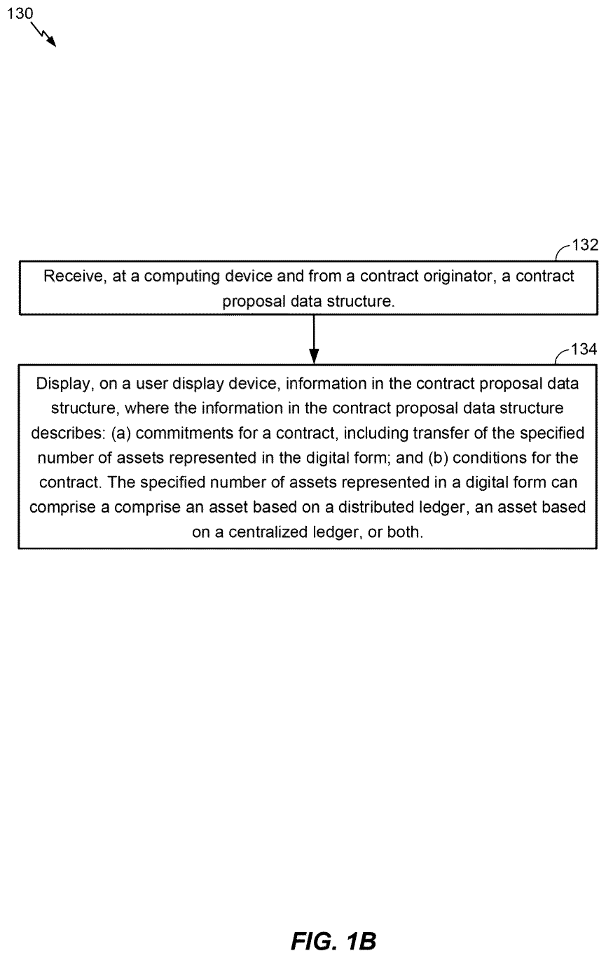

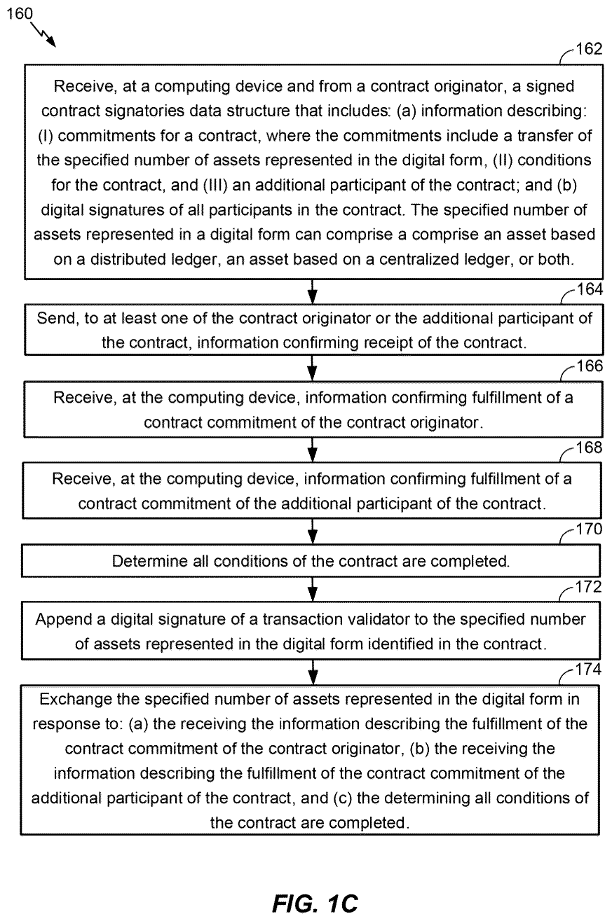

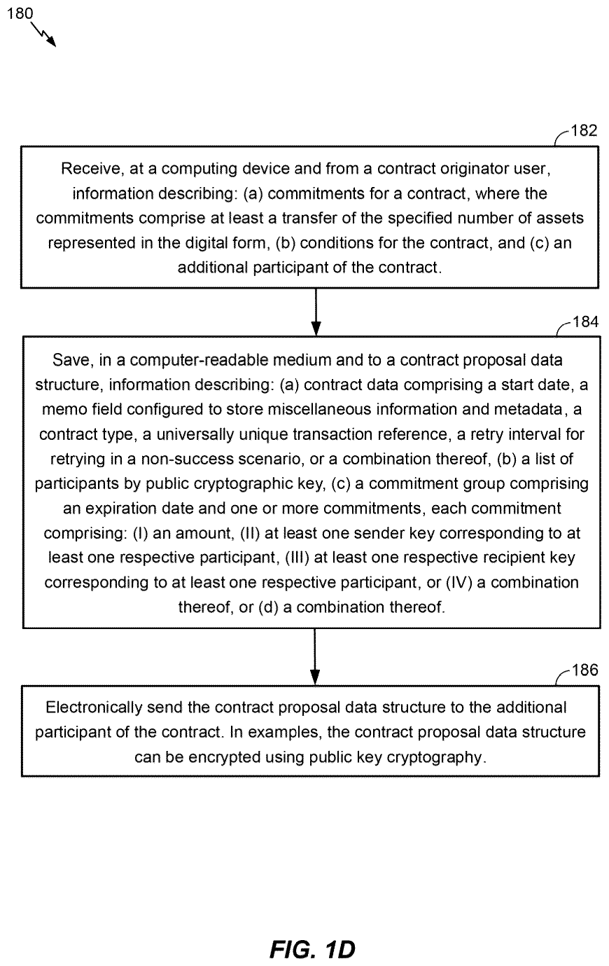

We now turn to FIG. 1A.

FIG. 1A depicts an example block diagram of an example method 100 for performing, by a contract originator machine, a contract-based transaction of a specified number of assets represented in a digital form, in accordance with an embodiment of the disclosure. The method 100 can be used to implement generating at least a portion of a contract originator machine, in accordance with an embodiment of the disclosure. In an embodiment, the method 100 can be implemented in a form of a set of computer-executable instructions. In examples, computer-executable instructions can include routines, programs, objects, components, data structures, procedures, operations, modules, functions, or a combination thereof, as non-limiting examples. Such computer-executable instructions can be executed by one or more programmed processors or co-processors.

The order in which the method 100 is described is not intended to be construed as a limitation, and any number of the described features can be combined in any order to implement the method 100 or alternate methods for automatically generating at least a portion of a contract originator machine. Additionally, individual features can be omitted, as is practicable, from the method 100 without departing from the scope of the subject matter described herein.

Furthermore, the method 100 can be implemented in any suitable hardware, software, firmware, or a combination thereof, such as the apparatus described hereby.

As shown in FIG. 1A, at step 102, one or more of the devices described herein can receive, at a computing device (i.e. the contract originator machine) and from a user originating a contract (e.g. a contract originator user), information describing: (a) commitments for a contract, where the commitments include a transfer of the specified number of assets represented in the digital form, (b) conditions for the contract, and (c) an additional participant of the contract.

In an example, the specified number of assets represented in a digital form can include an asset based on a distributed ledger. In an example, assets represented in a digital form can include an asset based on a distributed ledger.

In an example, the specified number of assets represented in a digital form can include an asset based on a centralized ledger. In an example, the assets represented in a digital form can include an asset based on a centralized ledger.

In nonlimiting examples the digital asset system can be digital payment network.

In an example, the contract proposal data structure can be encrypted using public key cryptography.

As shown in FIG. 1A, at step 104, one or more of the devices described herein can save, in a computer-readable medium and to a contract proposal data structure, (a) the information describing the commitments for the contract, (b) the conditions for the contract, and (c) the additional participant of the contract.

As shown in FIG. 1A, at step 106, one or more of the devices described herein can automatically electronically send the contract proposal data structure to the additional participant of the contract.

In an example, the method 100 can include receiving a proposal acknowledgment from the additional participant of the contract. The proposal acknowledgment can indicate the additional participant of the contract confirms receipt of the contract proposal data structure.

In an example, the method can further include (i) saving, in the computer-readable medium and to a contract request data structure, the information describing the commitments for the contract; the conditions for the contract; and the additional participant of the contract; (ii) encrypting the contract request data structure using public key cryptography; and (iii) electronically sending, to the additional participant of the contract, the contract request data structure.

In an example, the method 100 can include receiving, from the additional participant of the contract, an updated contract request data structure.

In an example, the method 100 can include (i) receiving an electronic signature of the contract originator user; (ii) saving, in the computer-readable medium and to a contract signatories data structure, the information describing information describing the commitments for the contract; the conditions for the contract, and the additional participant of the contract; (iii) saving the electronic signature of the contract originator user to the contract signatories data structure; and (iv) electronically sending, to the additional participant of the contract, the contract signatories data structure.

In an example, the method 100 can include receiving, from the additional participant of the contract, an updated contract signatories data structure, where the updated contract signatories data structure includes an electronic signature of the additional participant user and is encrypted using public key cryptography.

In an example, the method 100 can include electronically sending, to a transaction validator (i.e. the transaction validator machine), the updated contract signatories data structure.

In an example, the method 100 can further include receiving an electronic message including information describing a rejection of the contract and an electronic signature of a user who is an additional participant to the contract.

In some examples, one or more of the devices described herein can store at least an aspect of the method 100 (e.g., a comparison process, a user input, or a combination thereof) on a non-transitory computer-readable medium. In an example, the non-transitory computer-readable medium can be coupled to an electronic processor that is configured to execute at least a aspect of the contract originator machine stored on the non-transitory computer-readable medium. In an example, the electronic processor can execute at least a portion of an aspect of the contract originator machine stored on the non-transitory computer-readable medium.

In examples, at least a portion of the contract originator machine can be configured as a set of computer-executable instructions (e.g. software instructions), where the computer-executable instructions can be stored on a non-transitory computer-readable data storage device, a non-transitory computer-readable medium, or both.

We now turn to FIG. 1B.

FIG. 1B depicts an example block diagram of an example method 130 for performing, by an additional participant machine, a contract-based transaction of a specified number of assets represented in a digital form, in accordance with an embodiment of the disclosure.

The method 130 can be used to implement generating at least a portion of an additional participant machine, in accordance with an embodiment of the disclosure. In an embodiment, the method 130 can be implemented in a form of a set of computer-executable instructions. In examples, computer-executable instructions can include routines, programs, objects, components, data structures, procedures, operations, modules, functions, or a combination thereof, as non-limiting examples. Such computer-executable instructions can be executed by one or more programmed processors or co-processors.

The order in which the method 130 is described is not intended to be construed as a limitation, and any number of the described features can be combined in any order to implement the method 130 or alternate methods for automatically generating at least a portion of an additional participant machine. Additionally, individual features can be omitted, as is practicable, from the method 130 without departing from the scope of the subject matter described herein. Furthermore, the method 130 can be implemented in any suitable hardware, software, firmware, or a combination thereof, such as the apparatus described hereby.

As shown in FIG. 1B, at step 132, one or more of the devices described herein can receive, at the computing device (i.e. the additional participant machine) and from a contract originator (i.e. the contract originator machine), a contract proposal data structure.

In an example, the specified number of assets represented in a digital form can include an asset based on a distributed ledger. In an example, assets represented in a digital form can include an asset based on a distributed ledger.

In an example, the specified number of assets represented in a digital form can include an asset based on a centralized ledger. In an example, the assets represented in a digital form can include an asset based on a centralized ledger.

In an example, the information in the contract proposal data structure can further describe a listing of all participants to the contract. The method 130 can include displaying, on the user display device, at least one participant in the listing of all participants to the contract.

In an example, the contract proposal data structure can be encrypted using public key cryptography. The method 130 can further include decrypting the contract proposal data structure.

In an example, the method 130 can include sending, to the contract originator, an electronic proposal acknowledgment, where the electronic proposal acknowledgment confirms receipt of the contract proposal data structure.

As shown in FIG. 1B, at step 134, one or more of the devices described herein can display (e.g. on a user display device) information in the contract proposal data structure. The information in the contract proposal data structure can describe: (i) commitments for a contract, including transfer of the specified number of assets represented in the digital form; and (ii) conditions for the contract.

In an example, the method 130 can include (i) receiving, at the computing device and from the contract originator, the contract proposal data structure, where the contract proposal data structure is encrypted using public key cryptography; (ii) decrypting the contract proposal data structure; and (iii) displaying, on a user display device, information in the contract proposal data structure, where the information in the contract proposal data structure describes commitments for a contract and conditions for the contract.

In an example, the method 130 can further include (i) receiving, via a user interface device and from a user who is an additional participant of the contract, an instruction to send an updated contract request data structure; (ii) encrypting the updated contact request data structure using public key cryptography; and (iii) electronically sending, to the contract originator, the updated contract request data structure.

In some examples, the method 130 can further include receiving, via a user interface device and from an additional participant of the contract, an instruction to send an electronic rejection message to the contract originator machine. In some examples, the electronic rejection message can be digitally signed by the contract originator machine.

In an example, the method 130 can further include (i) receiving, at the computing device and from the contract originator, a contract signatories data structure, where the contract signatories data structure is encrypted using public key cryptography and comprises an electronic signature of the contract originator user; (ii) decrypting the contract signatories data structure; and (iii) displaying, on a user display device, information in the contract signatories data structure.

In an example, the method 130 can further include (i) receiving, from the user who is an additional participant of the contract, an instruction to send an updated contract signatories data structure; (ii) updating, in response to the instruction to send the updated contract signatories data structure, the contract signatories data structure with an electronic signature of the user who is an additional participant; (iii) encrypting the updated contact signatories data structure using public key cryptography; and (iv) electronically sending, to the contract originator, the updated contract signatories data structure.

In an example, the method 130 can further include determining an anti-money laundering condition is met, wherein meeting the anti-money laundering condition is a condition precedent to the exchanging the specified number of assets represented in the digital form identified in the contract.

In an example, the method 130 can further include determining an anti-money laundering condition is not met, wherein meeting the anti-money laundering condition is a condition precedent to the exchanging the specified number of assets represented in the digital form identified in the contract.

In an example, the method 130 can include (i) receiving, via a user interface device and from a user who is an additional participant to the contract, an instruction that the anti-money laundering condition is met; and (ii) sending, to the contract originator, an electronic message including information describing an acceptance of the contract.

In an example, the method 130 can include (i) receiving, via a user interface device and from a user who is an additional participant to the contract, an instruction that the anti-money laundering condition is not met; and (ii) sending, to the contract originator, an electronic message including information describing a rejection of the contract.

In an example, the method 130 can further include determining an anti-terrorism financing condition is met, wherein meeting the anti-terrorism financing condition is a condition precedent to the exchanging the specified number of assets represented in the digital form identified in the contract.

In an example, the method 130 can further include determining an anti-terrorism financing condition is not met, wherein meeting the anti-terrorism financing condition is a condition precedent to the exchanging the specified number of assets represented in the digital form identified in the contract.

In an example, the method 130 can include (i) receiving, via a user interface device and from a user who is an additional participant to the contract, an instruction that the anti-terrorism financing condition is met; and (ii) sending, to the contract originator, an electronic message including information describing an acceptance of the contract.

In an example, the method 130 can include (i) receiving, via a user interface device and from a user who is an additional participant to the contract, an instruction that the anti-terrorism financing condition is not met; and (ii) sending, to the contract originator, an electronic message including information describing a rejection of the contract.

In an example, the method 130 can further include determining a sanction condition is met, wherein meeting the sanctions condition is a condition precedent to the exchanging the specified number of assets represented in the digital form identified in the contract.

In an example, the method 130 can further include determining a sanction condition is not met, wherein meeting the sanctions condition is a condition precedent to the exchanging the specified number of assets represented in the digital form identified in the contract.

In an example, the method 130 can include (i) receiving, via a user interface device and from a user who is an additional participant to the contract, an instruction that the sanction condition is met; and (ii) sending, to the contract originator, an electronic message including information describing an acceptance of the contract.

In an example, the method 130 can include (i) receiving, via a user interface device and from a user who is an additional participant to the contract, an instruction that the sanction condition is not met; and (ii) sending, to the contract originator, an electronic message including information describing a rejection of the contract.

In an example, the method 130 can further include (i) receiving, via a user interface device and from a user who is an additional participant to the contract, an instruction to reject the contract described by the information in the contract proposal data structure; (ii) receiving, via the user interface device and from the user who is an additional participant to the contract, an electronic signature of the user who is an additional participant to the contract; and (iii) sending, to the contract originator, an electronic message including information describing a rejection of the contract and the electronic signature of the user who is an additional participant to the contract.

In some examples, one or more of the devices described herein can store at least an aspect of the method 130 (e.g., a comparison process, a user input, or a combination thereof) on a non-transitory computer-readable medium. In an example, the non-transitory computer-readable medium can be coupled to an electronic processor that is configured to execute at least a aspect of the additional participant machine stored on the non-transitory computer-readable medium. In an example, the electronic processor can execute at least a portion of an aspect of the additional participant machine stored on the non-transitory computer-readable medium.

In examples, at least a portion of the additional participant machine can be configured as a set of computer-executable instructions (e.g. software instructions), where the computer-executable instructions can be stored on a non-transitory computer-readable data storage device, a non-transitory computer-readable medium, or both.

We now turn to FIG. 1C.

FIG. 1C depicts an example block diagram of an example method 160 for performing, by a transaction validator machine, a contract-based transaction of a specified number of assets represented in a digital form, in accordance with an embodiment of the disclosure. The method 160 can be used to implement generating at least a portion of a transaction validator machine, in accordance with an embodiment of the disclosure. In an embodiment, the method 160 can be implemented in a form of a set of computer-executable instructions. In examples, computer-executable instructions can include routines, programs, objects, components, data structures, procedures, operations, modules, functions, or a combination thereof, as non-limiting examples. Such computer-executable instructions can be executed by one or more programmed processors or co-processors.

The order in which the method 160 is described is not intended to be construed as a limitation, and any number of the described features can be combined in any order to implement the method 160 or alternate methods for automatically generating at least a portion of a transaction validator machine. Additionally, individual features can be omitted, as is practicable, from the method 160 without departing from the scope of the subject matter described herein. Furthermore, the method 160 can be implemented in any suitable hardware, software, firmware, or a combination thereof, such as the apparatus described hereby.

In examples, the transaction validator machine can determine if a contract is to be completed or reversed. In examples, the transaction validator machine can instruct a digital asset system to perform a transfer of assets when all contract conditions are met and all contract commitments are met. The transaction validator machine can decide to not issue an instruction to perform a transfer of assets when at least one contract condition is not met, at least one contract commitment is not met, or both. To determine if contract commitments are met, the transaction validator machine can examine digital accounts to determine amounts of assets participants have deposited in respective accounts in escrow and compare the amounts to respective commitments for the contract. When at least one contract condition is not met, at least one contract commitment is not met, or both, the transaction validator machine can send electronic message to the contract originator, at least one additional party, or both indicating that the contract is incomplete.

In some examples, prior to the transaction validator machine instructing the digital asset system to perform the transfer of assets, the transaction validator machine can receive an instruction from the contract originator machine, the additional participant machine, or both instructing the transaction validator machine to cancel the transaction. In response, the transaction validator machine can send electronic instruction to the digital asset system instructing the digital asset system to revert escrow fulfillments.

As shown in FIG. 1C, at step 162, one or more of the devices described herein can receive, at the computing device (i.e. the transaction validator machine) and from a contract originator (i.e. the contract originator machine), a signed contract signatories data structure. The signed contract signatories data structure can include information describing: (I) commitments for a contract, where the commitments include a transfer of the specified number of assets represented in the digital form, (II) conditions for the contract, and (III) an additional participant of the contract (i.e. the additional participant machine). In examples, the signed contract signatories data structure can include digital signatures of all participants in the contract.

In an example, the specified number of assets represented in a digital form can include an asset based on a distributed ledger. In an example, assets represented in a digital form can include an asset based on a distributed ledger.

In an example, the specified number of assets represented in a digital form can include an asset based on a centralized ledger. In an example, the assets represented in a digital form can include an asset based on a centralized ledger.

In an example, the signed contract signatories data structure can be encrypted using public key cryptography. Some examples, the method 160 can further include decrypting the signed contract signatories data structure.

As shown in FIG. 1C, at step 164, one or more of the devices described herein can send, to the contract originator, to the additional participant of the contract, or both, information confirming receipt of the contract.

As shown in FIG. 1C, at step 166, one or more of the devices described herein can automatically receive, at the computing device, information confirming fulfillment of a contract commitment of the contract originator.

As shown in FIG. 1C, at step 168, one or more of the devices described herein can automatically receive, at the computing device, information confirming fulfillment of a contract commitment of the additional participant of the contract.

As shown in FIG. 1C, at step 170, one or more of the devices described herein can automatically determine all conditions of the contract are completed.

As shown in FIG. 1C, at step 172, one or more of the devices described herein can automatically append a digital signature of a transaction validator to the specified number of assets represented in the digital form identified in the contract.

As shown in FIG. 1C, at step 174, one or more of the devices described herein can automatically exchange the specified number of assets represented in the digital form in response to: (a) the receiving the information describing the fulfillment of the contract commitment of the contract originator, (b) the receiving the information describing the fulfillment of the contract commitment of the additional participant of the contract, and (c) the determining all conditions of the contract are completed.

In some examples, at step 174, one or more of the devices described herein can automatically issue an electronic instruction to a digital asset system instructing the digital asset system to exchange the specified number of assets represented in the digital form. The electronic instruction to the digital asset system can be issued in response to: (a) the receiving the information describing the fulfillment of the contract commitment of the contract originator, (b) the receiving the information describing the fulfillment of the contract commitment of the additional participant of the contract, and (c) the determining all conditions of the contract are completed.

In examples, the digital asset system can be a distributed ledger based asset payment network. In some examples, the digital asset system can be a centralized ledger based asset payment network.

In an example, the method 160 can further include checking for double spending (i.e. after performing step 162 and prior to performing step 170) by at least one of the contract originator or the additional participant of the contract, where an absence of double spending is a condition precedent to the exchanging the specified number of assets represented in the digital form identified in the contract.

In an example, the method 160 can further include determining (i.e. after performing step 162 and prior to performing step 170) a time deadline has not passed, where meeting the time deadline is a condition precedent to the exchanging the specified number of assets represented in the digital form identified in the contract.

In an example, methods described herein can further include determining (i.e. after performing step 162 and prior to performing step 170) an anti-money laundering condition is met, where meeting the anti-money laundering condition is a condition precedent to the exchanging the specified number of assets represented in the digital form identified in the contract. In examples, a user device described herein can receive user input information describing user acceptance or user rejection of a respective contract in response to the determining if the anti-money laundering condition is met.

In an example, the methods described herein can further include determining (i.e. after performing step 162 and prior to performing step 170) an anti-terrorism financing condition is met, where meeting the anti-terrorism financing condition is a condition precedent to the exchanging the specified number of assets represented in the digital form identified in the contract. In examples, a user device described herein can receive user input information describing user acceptance or user rejection of a respective contract in response to the determining if the anti-terrorism financing condition is met.

In an example, the methods described herein can further include determining (i.e. after performing step 162 and prior to performing step 170) a sanction condition is met, where meeting the sanctions condition is a condition precedent to the exchanging the specified number of assets represented in the digital form identified in the contract. In examples, a user device described herein can receive user input information describing user acceptance or user rejection of a respective contract in response to the determining if the sanctions condition is met.

In an example, the methods described herein can further include determining (i.e. after performing step 162 and prior to performing step 170) an address validation condition is met, where meeting the address validation condition is a condition precedent to the exchanging the specified number of assets represented in the digital form identified in the contract. In examples, a user device described herein can receive user input information describing user acceptance or user rejection of a respective contract in response to the determining if address validation condition is met.

In some examples, one or more of the devices described herein can store at least an aspect of the method 160 (e.g., a comparison process, a user input, or a combination thereof) on a non-transitory computer-readable medium. In an example, the non-transitory computer-readable medium can be coupled to an electronic processor that is configured to execute at least a aspect of the transaction validator machine stored on the non-transitory computer-readable medium. In an example, the electronic processor can execute at least a portion of an aspect of the transaction validator machine stored on the non-transitory computer-readable medium.

In examples, at least a portion of the transaction validator machine can be configured as a set of computer-executable instructions (e.g. software instructions), where the computer-executable instructions can be stored on a non-transitory computer-readable data storage device, a non-transitory computer-readable medium, or both.

We now turn to FIG. 1D.

FIG. 1D depicts an example block diagram of an example method 180 for performing, by a machine, a contract-based transaction of a specified number of assets represented in a digital form, in accordance with an embodiment of the disclosure. The method 180 can be used to implement generating at least a portion of a contract originator machine, in accordance with an embodiment of the disclosure. In an embodiment, the method 180 can be implemented in a form of a set of computer-executable instructions. In examples, computer-executable instructions can include routines, programs, objects, components, data structures, procedures, operations, modules, functions, or a combination thereof, as non-limiting examples. Such computer-executable instructions can be executed by one or more programmed processors or co-processors.

The order in which the method 180 is described is not intended to be construed as a limitation, and any number of the described features can be combined in any order to implement the method 180 or alternate methods for automatically generating at least a portion of a contract originator machine. Additionally, individual features can be omitted, as is practicable, from the method 180 without departing from the scope of the subject matter described herein.

Furthermore, the method 180 can be implemented in any suitable hardware, software, firmware, or a combination thereof, such as the apparatus described hereby.

As shown in FIG. 1D, at step 182, one or more of the devices described herein can receive, at a computing device and from a contract originator user, information describing: (a) commitments for a contract, where the commitments comprise at least a transfer of the specified number of assets represented in the digital form, (b) conditions for the contract, and (c) an additional participant of the contract.

As shown in FIG. 1D, at step 184, one or more of the devices described herein can save, in a computer-readable medium and to a contract proposal data structure, information describing: (a) contract data comprising a start date, a memo field configured to store miscellaneous information and metadata, a contract type, a universally unique transaction reference, a retry interval for retrying in a non-success scenario, or a combination thereof, (b) a list of participants by public cryptographic key, (c) a commitment group comprising an expiration date and one or more commitments, each commitment comprising: (I) an amount, (II) at least one sender key corresponding to at least one respective participant, (III) at least one respective recipient key corresponding to at least one respective participant, or (IV) a combination thereof, or (d) a combination thereof.

As shown in FIG. 1D, at step 186, one or more of the devices described herein can electronically send the contract proposal data structure to the additional participant of the contract. In examples, the contract proposal data structure can be encrypted using public key cryptography.

In an example, the method 180 can further include receiving an electronic proposal acknowledgment from the additional participant of the contract. The electronic proposal acknowledgment can indicate the additional participant of the contract confirms receipt of the contract proposal data structure.

In an example, the method 180 can further include (i) saving, in the computer-readable medium and to a contract request data structure, the information describing the commitments for the contract; the conditions for the contract; and the additional participant of the contract; (ii) encrypting the contract request data structure using public key cryptography; and (iii) electronically sending, to the additional participant of the contract, the contract request data structure.

In an example, the method 180 can further include receiving, from the additional participant of the contract, an updated contract request data structure.

In an example, the method 180 can further include (i) receiving an electronic signature of the contract originator user; (ii) saving, in the computer-readable medium and to a contract signatories data structure, the information describing the commitments for the contract; the conditions for the contract; and the additional participant of the contract; (iii) saving the electronic signature of the contract originator user to the contract signatories data structure; and (iv) electronically sending, to the additional participant of the contract, the contract signatories data structure.

In an example, the method 180 can further include receiving, from the additional participant of the contract, an updated contract signatories data structure. The updated contract signatories data structure can include an electronic signature of an additional participant user. The updated contract signatories data structure can be encrypted using public key cryptography.

In an example, the method 180 can further include electronically sending, to a transaction validator, an updated contract signatories data structure.

In an example, the specified number of assets represented in a digital form can include an asset based on a distributed ledger, an asset based on a centralized ledger, or both.

In an example, the information in the contract proposal data structure can further describe a listing of all participants to the contract. The method 180 can further include displaying, on a user display device, at least one participant in the listing of all participants to the contract.

In an example, the method 180 can further include sending, to the contract originator, an electronic proposal acknowledgment. The electronic proposal acknowledgment can confirm receipt of the contract proposal data structure.

In an example, the method 180 can further include (i) receiving, at another computing device and from the contract originator, the contract proposal data structure; (ii) decrypting the contract proposal data structure; and (iii) displaying, on a user display device, information in the contract proposal data structure. The information in the contract proposal data structure can describe the commitments for a contract, the conditions for the contract, or both.

In an example, the method 180 can further include (i) receiving, via a user interface device and from a user who is an additional participant of the contract, an instruction to send an updated contract request data structure; (ii) encrypting the updated contract request data structure using public key cryptography; and (iii) electronically sending, to the contract originator, the updated contract request data structure.

In an example, the method 180 can further include (i) receiving, at another computing device and from the contract originator, a contract signatories data structure, where the contract signatories data structure is encrypted using public key cryptography and includes an electronic signature of the contract originator user; (ii) decrypting the contract signatories data structure; and (iii) displaying, on a user display device, information in the contract signatories data structure.

In an example, the method 180 can further include (i) receiving, from a user who is an additional participant of the contract, an instruction to send an updated contract signatories data structure; (ii) updating, in response to the instruction to send the updated contract signatories data structure, the contract signatories data structure with an electronic signature of the user who is the additional participant; (iii) encrypting the updated contract signatories data structure using public key cryptography; and (iv) electronically sending, to the contract originator, the updated contract signatories data structure.

In an example, the method 180 can further include determining that a condition requiring an absence of unlawful activity is met. The meeting the condition requiring the absence of the unlawful activity can be a condition precedent to exchanging the specified number of assets represented in the digital form identified in the contract.

In an example, the method 180 can further include (i) receiving, at another computing device and from the contract originator, the contract proposal data structure; and (ii) displaying, on a user display device, information in the contract proposal data structure, where the information in the contract proposal data structure describes: (a) the commitments for the contract, including transfer of the specified number of assets represented in the digital form, (b) the conditions for the contract, or (c) both.

In an example, the method 180 can further include decrypting the contract proposal data structure.

In an example, the method 180 can further include: (i) receiving, via a user interface device and from a user who is an additional participant to the contract, an instruction to reject the contract described by the information in the contract proposal data structure; (ii) receiving, via the user interface device and from the user who is an additional participant to the contract, an electronic signature of the user who is an additional participant to the contract; and (iii) sending, to the contract originator, an electronic message including information describing a rejection of the contract and the electronic signature of the user who is an additional participant to the contract.

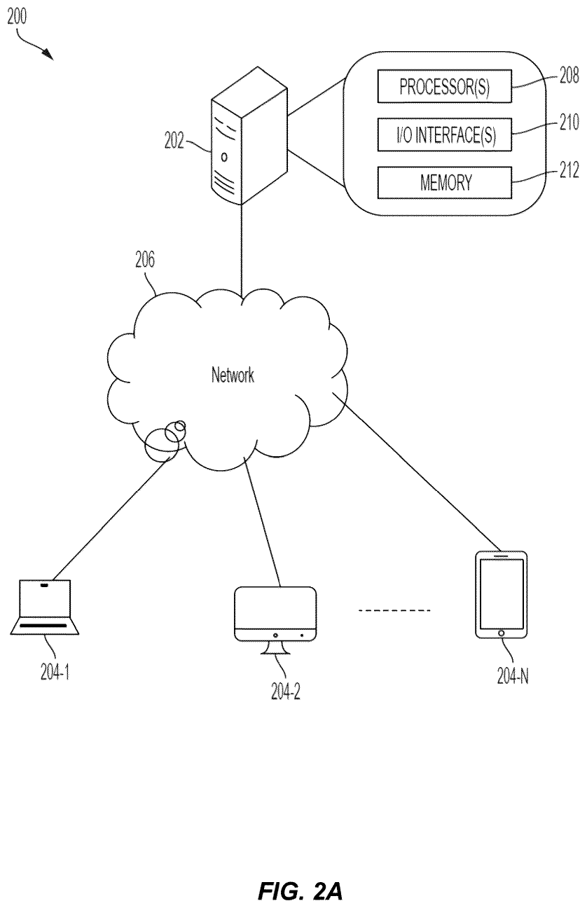

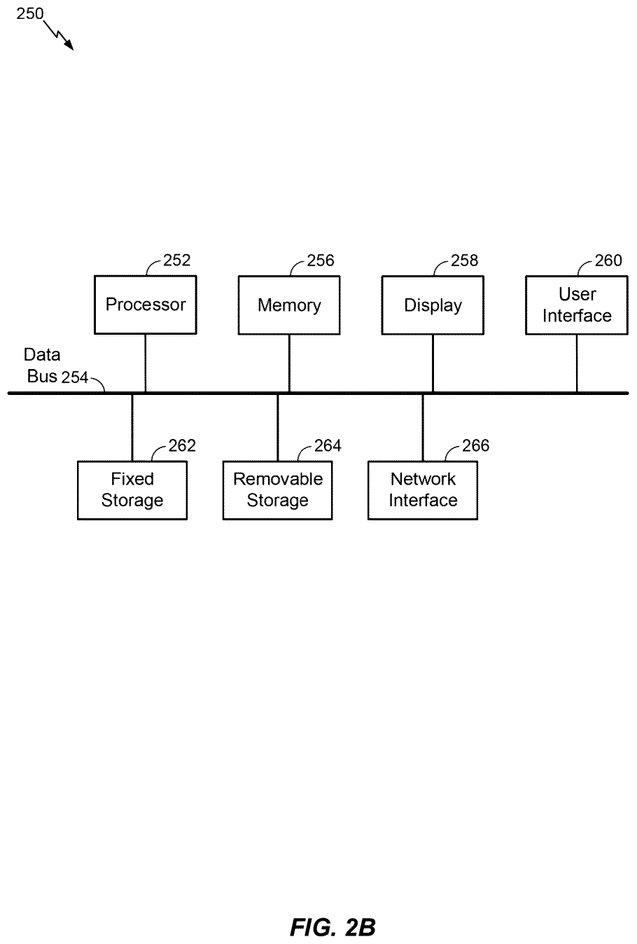

We now turn to FIG. 2A.

FIG. 2A depicts a network implementation 200 of a system 202. One or more users can access the system 202 through one or more user devices 204-1, 204-2 . . . 204-N, collectively referred to as user devices 204, hereinafter, or applications residing on the user devices 204.

Although the disclosure is explained considering that the system 202 is implemented on a server, the system 202 can be implemented in other forms of a computing device or system, such as a laptop computer, a desktop computer, a notebook, a workstation, a virtual environment, a mainframe computer, a server, a network server, or a cloud-based computing environment. It will be understood that the system 202 can be accessed by multiple users through one or more user devices 204-1, 204-2 . . . 204-N.

In one implementation, the system 202 can comprise a cloud-based computing environment in which the user can operate individual computing systems configured to execute remotely located applications. Examples of the user devices 204 can include, but are not limited to, a portable computer, a personal digital assistant, a handheld device, a workstation, or a combination thereof. The user devices 204 can be communicatively coupled to the system 202 through a network 206.

In one implementation, the network 206 can be a wireless network, a wired network, or a combination thereof. The network 206 can be implemented as one of several different types of networks, including but not limited to an intranet, local area network (LAN), wide area network (WAN), the Internet, or a combination thereof. The network 206 can be a dedicated network or a shared network. A shared network can be an association of different types of networks that use a variety of protocols, for example, Hypertext Transfer Protocol (HTTP), Transmission Control Protocol/Internet Protocol (TCP/IP), or Wireless Application Protocol (WAP) to communicate with one another. Further, the network 206 can include a variety of network devices, including routers, bridges, servers, computing devices, storage devices, or a combination thereof.

In an embodiment, system 202 can include at least one processor 208, an input/output (I/O) interface 210, and a memory 212. The processor 208 can be implemented as one or more microprocessors, microcomputers, microcontrollers, digital signal processors, Central Processing Units (CPUs), state machines, logic circuitries, devices that manipulate signals based on operational instructions, or a combination thereof. Among other capabilities, the at least one processor 208 can be configured to fetch and execute computer-readable instructions stored in the memory 212.

The in/out (I/O) interface 210 can include software and hardware interfaces, for example, a web interface, a graphical user interface (GUI, UI), and the like. The I/O interface 210 can allow the system 202 to interact with the user directly or through at least one of the client devices 204-1 to 204-N. Further, the I/O interface 210 can enable the system 202 to communicate with other computing devices, such as web servers and external data servers (not shown). The I/O interface 210 can facilitate communications and data transfer within a wide variety of networks and protocol types, including wired networks (for example, Local Area Network or cable) and wireless networks (such as wireless local area network, a cellular network, or a satellite network). The I/O interface 210 can include one or more ports for connecting a number of devices to one another or to another server.

The memory 212 can include a computer-readable medium or computer program product.

Non-limiting examples include volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 212 can include routines, programs, objects, instructions, modules, components, or data structures which perform particular tasks or implement particular abstract data types. The memory 212 can include programs or instructions that supplement applications and functions of the system 202. In an embodiment, the memory 212 can serve as a repository for storing data processed, received, generated or a combination thereof by one or more programs or coded instructions.

We now turn to FIG. 2B.

FIG. 2B depicts an example diagram of an example computing device 250 suitable for implementing examples of the disclosed subject matter. For example, at least a portion of the computing device 250 can be suitable for use as a component part of the system 202, at least one of the user devices 204-1 to 204-N, or a combination thereof. In another example, at least a portion of the computing device 250 can be coupled to the network 206.

In examples, a process management machine can include at least a portion of the example computing device 250, at least a portion of the system 202, or both, configured with computer-executable instructions to perform at least a portion of a technique described hereby, where the computer-executable instructions can be stored on a non-transitory computer-readable data storage device, a non-transitory computer-readable medium, or both.

In examples, aspects of the computing device 250 can be implemented at least in part in a desktop computer, a laptop computer, a server, a mobile device, a special-purpose computer, a non-generic computer, an electronic device described hereby (as is practicable), the like, or a combination thereof. In some examples, the disclosed subject matter can be implemented in, and used with, hardware devices, computer network devices, the like, or a combination thereof. The configuration depicted in FIG. 2B is an illustrative example and is not limiting.

In some examples, the computing device 250 can include a processor 252, a data bus 254, a memory 256, a display 258, a user interface 260, a fixed storage device 262, a removable storage device 264, a network interface 266, the like, or a combination thereof. These elements are described in further detail herein.

The processor 252 can be a hardware-implemented processing unit configured to control at least a portion of operation of the computing device 250. The processor 252 can perform logical and arithmetic operations based on processor-executable instructions stored within the memory 256. The processor 252 can be configured to execute instructions that cause the processor 252 to initiate at least a part of a method described hereby. In an example, the processor 252 can interpret instructions stored in the memory 256 to initiate at least a part of a method described hereby. In an example, the processor 252 can execute instructions stored in the memory 256 to initiate at least a part of a method described hereby. The instructions, when executed by the processor 252, can transform the processor 252 into a special-purpose processor that causes the processor to perform limited functions including at least a part of a function described hereby. The processor 252 can also be referred to as a central processing unit (CPU), a special-purpose processor (e.g. a non-generic processor), or both.

In some examples, the computing device 250 can implement machine-learning techniques (e.g. using a Convolutional Neural Network (CNN), etc.) to collect information, process information, or both. In some examples, the provided apparatuses can be configured to perform a neural network convolution on at least a portion of information described herein.

As used herein, the acronym “CNN” refers to a Convolutional Neural Network. A CNN is a type of feed-forward neural network which can process and collect portions of input information. Thus, the CNN can receive input data and provide a prediction (i.e. a forecast) having a high level of probability.

As used herein, the acronym “LSTM” refers to a Long Short-Term Memory neural network. An LSTM is a type of recurrent feed-forward neural network architecture which can be trained to classify input data. An LSTM is trained on a training data set, such as a training data set having known-accurate information. Thus, the LSTM can receive input data and provide a prediction (i.e. a forecast) having a high level of probability. The LSTM includes intermediate hidden layers of processing units which perform a function on data input from a preceding layer. The output from a hidden layer is a “hidden state.” The hidden state is “hidden” in the sense that the hidden state is not an output from an output layer. In some examples, the provided apparatuses can be configured to perform a neural network convolution, using a hidden layer, on at least a portion of information described herein.

In some examples, the provided methods can include performing a neural network convolution on at least a portion of information described herein. In some examples, the provided methods can include using a machine learning model to perform at least a portion of a method described herein. In some examples, the provided methods can include training a machine learning model to perform at least a portion of a method described herein. In some examples, information stored in an information storage device of the computing device 250 can be transferred to another computing device.

In some examples, the provided techniques can advantageously improve functioning of machine learning models configured to perform contract-based transactions. For example, the provided techniques can advantageously improve efficiency of machine learning models configured to perform contract-based transactions. The provided techniques can advantageously improve functioning of computers configured to perform contract-based transactions and other technologies configured to perform contract-based transactions.

The processor 252 can comprise or be a component of a physical processing system implemented with one or more processors. In some examples, the processor 252 can be implemented with at least a portion of: a microprocessor, a microcontroller, a digital signal processor (DSP) integrated circuit, a field programmable gate array (FPGA), a programmable logic device (PLD), an application-specific integrated circuit (ASIC), a controller, a state machine, a gated logic circuit, a discrete hardware component, a dedicated hardware finite state machine, a finite state machine configured to perform at least a portion of a stage of contract negotiation, finite state machine configured to perform execution of at least a portion of a contract-based transaction, a suitable physical device configured to manipulate information (e.g., calculating, logical operations, the like, or a combination thereof), the like, or a combination thereof.

The data bus 254 can couple components of the computing device 250. The data bus 254 can enable information communication between the processor 252 and one or more components coupled to the processor 252. In some examples, the data bus 254 can include a data bus, a power bus, a control signal bus, a status signal bus, the like, or a combination thereof. In an example, the components of the computing device 250 can be communicatively coupled together to communicate with each other using a different suitable mechanism.

The memory 256 generally represents any type or form of volatile storage device, non-volatile storage device, medium, the like, or a combination thereof. The memory 256 can store data (e.g. a database), processor-readable instructions, the like, or a combination thereof. In an example, the memory 256 can store data, load data, maintain data, or a combination thereof. In an example, the memory 256 can store processor-readable instructions, load processor-readable instructions, maintain processor-readable instructions, or a combination thereof. In some embodiments, the memory 256 can store computer-readable instructions configured to cause a processor (e.g. the processor 252) to initiate performing at least a portion of a method described hereby. The memory 256 can be a main memory configured to store an operating system, an application program, the like, or a combination thereof. The memory 256 can store a basic input-output system (BIOS) which can control basic hardware operation such as interaction of the processor 252 with peripheral components. The memory 256 can also include a non-transitory machine-readable medium configured to store software. Software can mean any type of instructions, whether referred to as at least one of software, firmware, middleware, microcode, hardware description language, the like, or a combination thereof. Processor-readable instructions can include code (e.g., in source code format, in binary code format, executable code format, or in any other suitable code format).

The memory 256 can include at least one of read-only memory (ROM), random access memory (RAM), a flash memory, a cache memory, an erasable programmable read-only memory (EPROM), an electrically erasable programmable read-only memory (EEPROM), a register, a hard disk drive (HDD), a solid-state drive (SSD), an optical disk drive, other memory, the like, or a combination thereof which is configured to store information (e.g., data, processor-readable instructions, software, a database, the like, or a combination thereof) and is configured to provide the information to the processor 252.

The display 258 (i.e. a user display device) can include a component configured to visually convey information to a user of the computing device 250. In examples, the display 258 can be a video display screen, such as a light-emitting diode (LED) screen, a touch screen, or both. In examples, the display 258 can display, such as via a user interface, information described herein, information produced by at least a portion of a method described herein, or both. In examples, the display 258 can display a graphical user interface (GUI).

The user interface 260 can include user devices such as a switch, a computer mouse, a trackpad, a keypad, a keyboard, a touch screen, a microphone, a speaker, an audio production device, a camera, a jack for coupling the computing device to an audio production device, the like, or a combination thereof. The user interface 260 can optionally include a user interface controller. The user interface 260 can include a component configured to convey information to a user of the computing device 250, a component configured to receive information from the user of the computing device 250, or both. In examples, the user interface 260 can include the display 258.

The fixed storage device 262 can include one or more hard drive, flash storage device, the like, or a combination thereof. The fixed storage device 262 can be an information storage device (e.g. storing a database) that is not configured to be removed during use. The fixed storage device 262 can optionally include a fixed storage device controller. The fixed storage device 262 can be integral with the computing device 250 or can be separate and accessed through an interface.

The removable storage device 264 can be integrated with the computing device 250 or can be separated and accessed through other interfaces. The removable storage device 264 can be an information storage device (e.g. storing a database) that is configured to be removed during use, such as a memory card, a jump drive, a flash storage device, an optical disk, the like, or a combination thereof. The removable storage device 264 can optionally include a removable storage device controller. The removable storage device 264 can be integrated with the computing device 250 or can be separate and accessed through an interface.

In examples, a computer-readable storage medium such as one or more of the memory 256, the fixed storage device 262, the removable storage device 264, a remote storage location, the like, or a combination thereof can store non-transitory computer-executable instructions configured to cause a processor (e.g. the processor 252) to implement at least an aspect of the present disclosure.

The network interface 266 can couple the processor 252 (e.g. via the data bus 254) to a network and enable exchanging information between the processor 252 and the network. In some examples, the network interface 266 can couple the processor 252 (e.g. via the data bus 254) to the network and enable exchanging information between the processor 252 and another computing device. For example, the network interface 266 can enable the processor 252 to communicate with one or more other network devices. The network interface 266 can couple to the network using any suitable technique and any suitable protocol. In some examples, the network interface 266 can include a data bus, a power bus, a control signal bus, a status signal bus, the like, or a combination thereof. Example techniques and protocols the network interface 266 can be configured to implement include digital cellular telephone, WiFi™, Bluetooth®, near-field communications (NFC), the like, or a combination thereof.

The network can couple the processor 252 to one or more other network devices. In some examples, the network can enable exchange of information between the processor 252 and the one or more other network devices. In some examples, the network can enable exchange of information between the processor 252 and another computing device. The network can include one or more private networks, local networks, wide-area networks, the Internet, other communication networks, the like, or a combination thereof. In some examples, the network can be a wired network, a wireless network, an optical network, the like, or a combination thereof.

In some embodiments, the network device can store computer-readable instructions configured to cause a processor (e.g. the processor 252) to initiate performing at least a portion of a method described hereby. In an example, the one or more other network devices can store non-transitory computer-executable instructions configured to cause a processor (e.g. the processor 252) to implement at least an aspect of the present disclosure. The non-transitory computer-executable instructions can be received by the processor 252 and implemented using at least a portion of techniques described hereby. In another example, information described hereby can be stored in the fixed storage device 262, the removable storage device 264, the network device, the like, or a combination thereof.

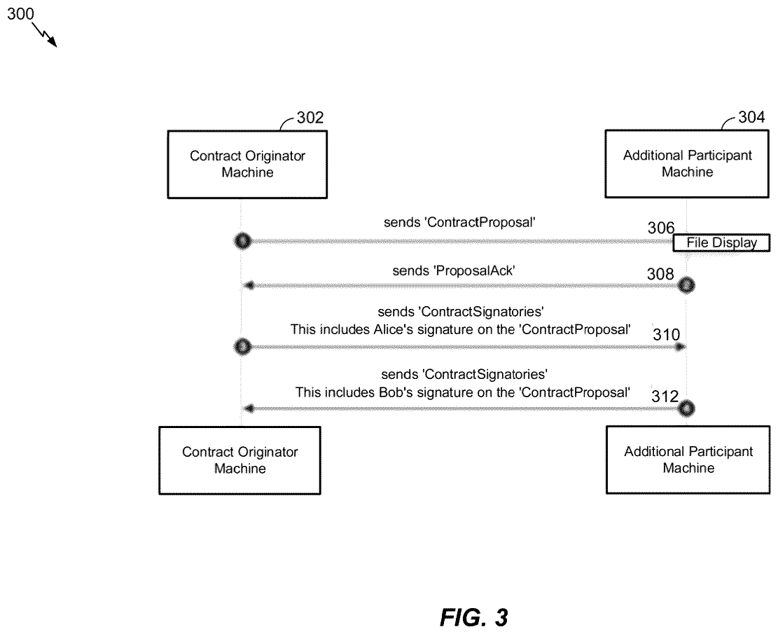

We now turn to FIG. 3.

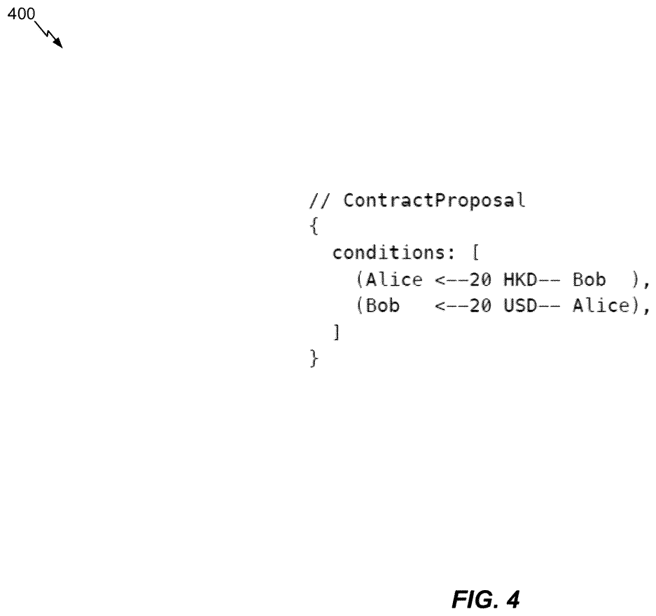

FIG. 3 depicts a non-limiting example method 300 for performing, by a contract originator machine 302 and an additional participant machine 304, a contract-based transaction of a specified number of assets represented in a digital form, in accordance with an embodiment of the disclosure. FIGS. 4-8 depict example contract negotiation message payloads corresponding to respective steps in the method 300.

The order in which the method 300 is described is not intended to be construed as a limitation, and any number of the described features can be combined in any order to implement the method 300 or alternate methods for automatically generating at least a portion of a contract-based transaction system. Additionally, individual features can be omitted, as is practicable, from the method 300 without departing from the scope of the subject matter described herein. Furthermore, the method 300 can be implemented in any suitable hardware, software, firmware, or a combination thereof, such as the apparatus described hereby.

As shown in FIG. 3, at step 306, the contract originator machine 302 (e.g. controlled by a user named Alice), sends an electronic contract proposal message to the additional participant machine 304 (e.g. controlled by the user named Bob). FIG. 4 depicts an example payload 400 of the electronic contract proposal message.

As shown in FIG. 3, at step 308, the additional participant machine 304 sends an electronic proposal acknowledgment message to the contract originator machine 302.

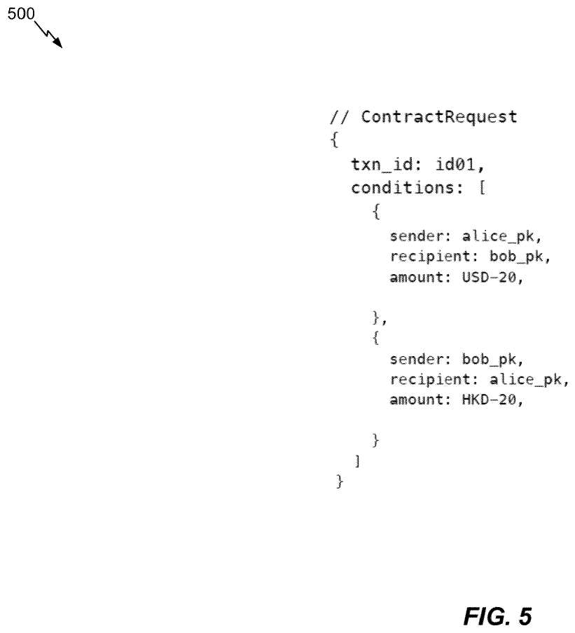

FIG. 5 depicts an example payload 500 of an electronic first contract request message. The contract originator machine 302 can send an electronic first contract request message to the additional participant machine 304.

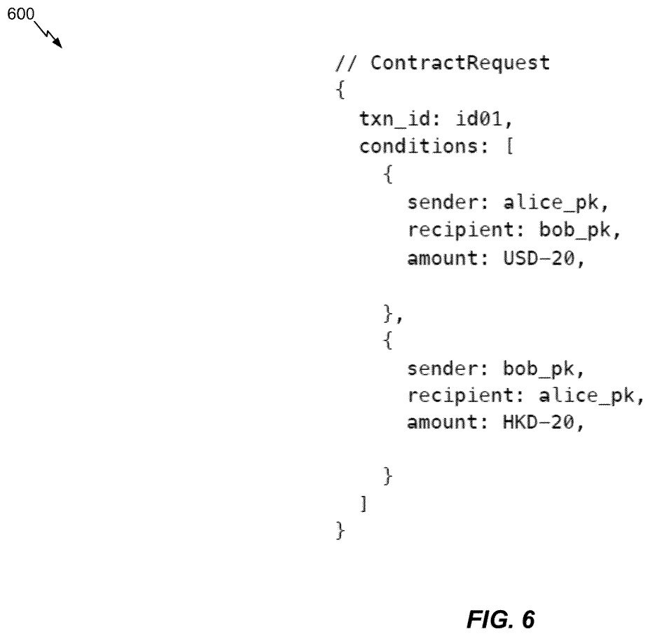

FIG. 6 depicts an example payload 600 of an electronic second contract request message. The additional participant machine 304 can send an electronic second contract request message to the contract originator machine 302.

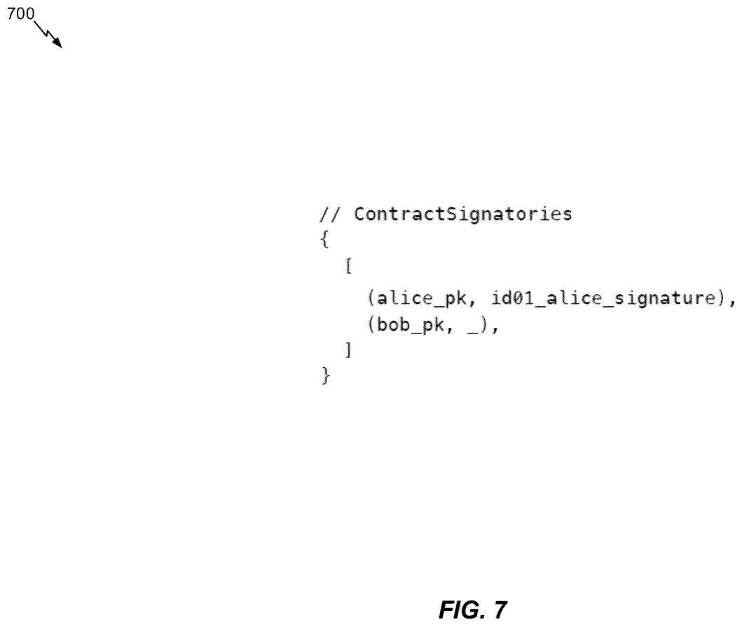

As shown in FIG. 3, at step 310, the contract originator machine 302 sends an electronic first contract signatories message to the additional participant machine 304. The first contract signatories message includes a digital signature of the user of the contract originator machine 302. FIG. 7 depicts an example payload 700 of the electronic first contract signatories message.

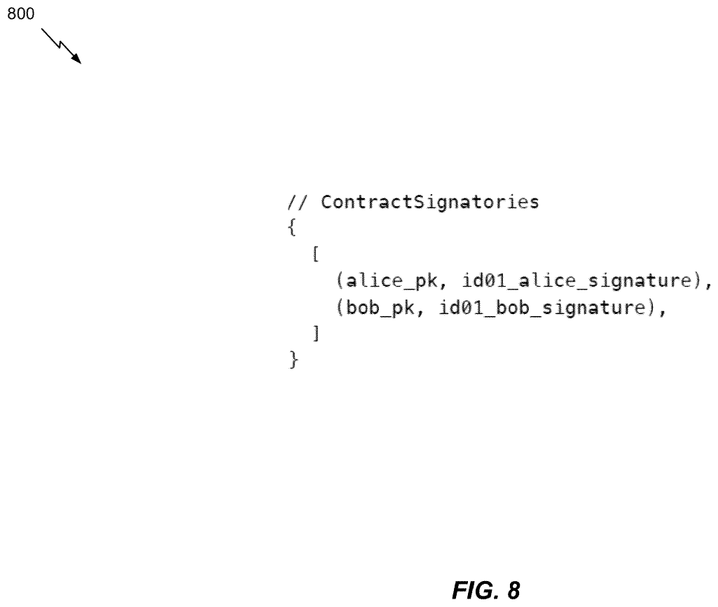

As shown in FIG. 3, at step 312, the additional participant machine 304 sends an electronic second contract signatories message to the contract originator machine 302. The second contract signatories message includes digital signature of the user of the additional participant machine 304. FIG. 8 depicts an example payload 800 of the electronic second contract request message.

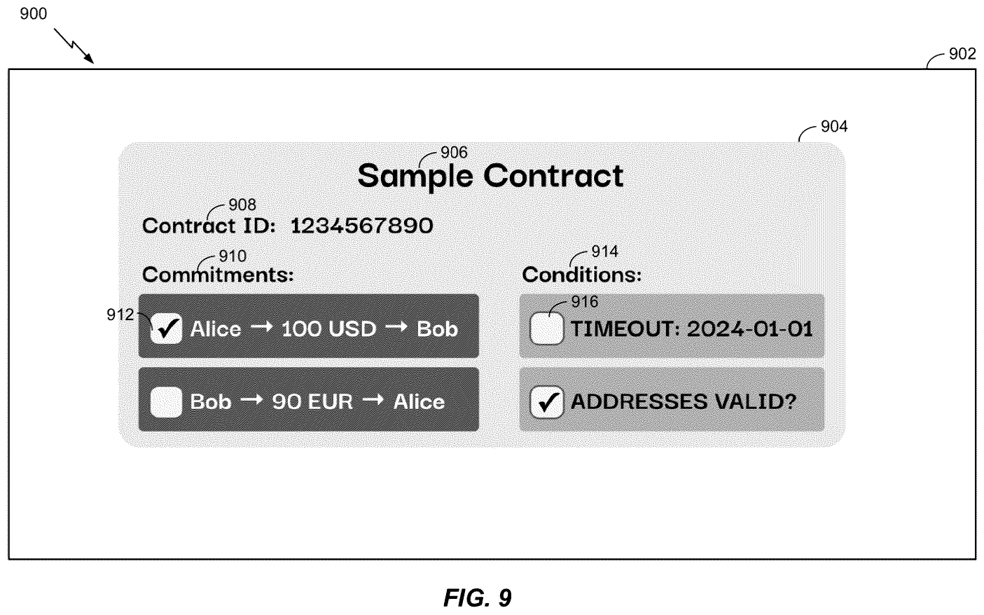

We now turn to FIG. 9.

FIG. 9 is a diagram depicting a non-limiting example user interface 900 including a user display or portion thereof 902 with an example of a page of a graphical user interface 904 of a contract-based transactions machine, in accordance with an embodiment of the disclosure.

The graphical user interface 904 can include information describing contract title 906, a contract identification number 908, a per-participant list of commitments 910, a per-commitment indication of the status of the respective commitment 912, a list of contract conditions 914, a per-condition indication of a status of the respective condition 916, or a combination thereof. The graphical user interface 904 can provide a user interface to enable a user to input information that creates an electronic contract proposal message. Examples, the graphical user interface 904 can include drop-down boxes, radio buttons, etc. to enable the user to enter information describing aspects of the electronic contract proposal message.

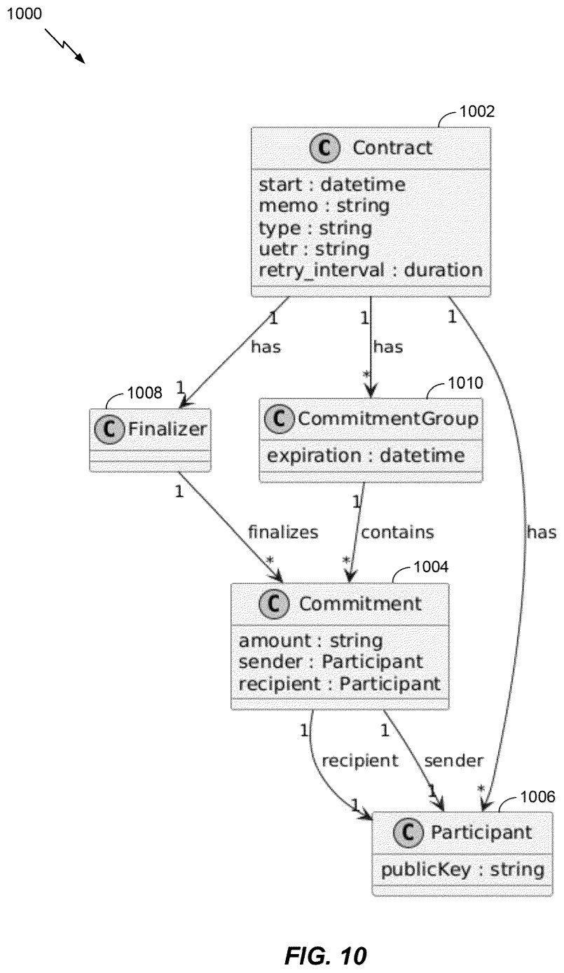

We now turn to FIG. 10.

FIG. 10 depicts a non-limiting example entity relationship diagram 1000 that illustrates the structural components and interconnections within a contract-based transaction system. The example entity relationship diagram 1000 depicts an example fundamental architecture of contract management and participant interaction within a system framework, in accordance with an embodiment of the disclosure. The example entity relationship diagram 1000 depicts a contract data structure 1002, a commitment data structure 1004, a participant data structure 1006, a finalizer 1008, and a commitment group 1010.

The contract data structure 1002 can include information describing attributes of a contract. The start attribute can be configured as a datetime data type and can specify a time when the contract becomes active within the system. The memo attribute can be implemented as a string data type and can provide a field for storing miscellaneous information associated with the contract, metadata associated with the contract, or both. The type attribute can be defined as a string data type and can categorize a specific classification of the contract within a system taxonomy. The Unique End-to-end Transaction Reference (UETR) attribute can be configured as a string data type and can include information describing a universally unique transaction reference that provides distinct identification for each contract instance. The retry_interval attribute can be implemented as a duration data type and can specify a time interval for retrying contract operations in non-success scenarios.

The contract data structure 1002 can have distinct relationship connections that extend to other system components. A first relationship can be between the contract data structure 1002 and a finalizer 1008. The finalizer 1008 can complete and validate contract execution procedures.

A second relationship can be between the contract data structure 1002 and a commitment group 1010. The commitment group 1010 can serve as an organizational container for related commitment instances within a single contract. The commitment group 1010 can include an expiration attribute, which can be configured as a datetime data type. The expiration attribute can specify a time when the commitment group becomes invalid or expires within the contract framework.

The commitment group 1010 can maintain distinct relationship connections within the contract architecture. A relationship can be between the commitment group 1010 and a commitment data structure 1004, that enables commitment validation and completion procedures.

The commitment data structure 1004 can represent an individual asset transfer obligation within the contract framework. The commitment data structure 1004 can include attributes defining operational parameters of each commitment instance. An amount attribute can be configured as a string data type and can specify the precise quantity of assets to be transferred as part of the commitment. A sender attribute can be defined as a Participant data type and can identify a party responsible for providing the assets specified in the commitment data structure 1004. A recipient attribute can be configured as a Participant data type and can identify a party designated to receive the assets specified in the commitment data structure 1004.

The commitment data structure 1004 can have distinct relationship connections that link the commitment data structure 1004 to participant data structures. The first relationship can be labeled “sender” and can connect the commitment data structure 1004 to a participant data structure 1006, establishing an identity of a party providing assets for the commitment. The second relationship can be labeled “recipient” and can connect the commitment data structure 1004 to another participant data structure, establishing an identity of a party receiving assets from the commitment.

The participant data structure 1006 can represent individual parties involved in contract-based transactions. The participant data structure 1006 can include an attribute designated as publicKey, which can be configured as a string data type. The publicKey attribute can store a cryptographic public key associated with each participant, enabling digital signature verification and secure communication within the contract-based transaction system.

The cardinality indicators positioned throughout FIG. 10 can specify the numerical relationships between connected entities. The “1” indicators can represent one-to-one relationships, while the “*” indicators can represent one-to-many relationships. These cardinality specifications can define the structural constraints and data integrity requirements within the contract-based transaction system architecture.

Exemplary embodiments discussed herein can provide certain advantages. These advantages can include those provided by the disclosed features.

Although systems and methods for generating a contract-based transactions machine are described hereby in a language specific to structural features and/or methods, the appended claims are not necessarily limited to the specific features or methods described. Rather, the specific features and methods are disclosed as examples of implementations for generating a contract-based transactions machine.

One or more embodiments of the disclosed subject matter are described herein with specificity to meet statutory requirements, but this description does not limit the scope of the claims. The claimed subject matter can be embodied in other ways, can include different elements or steps, and can be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure can be practiced. The disclosure may, however, be embodied in different forms and should not be construed as limited to the embodiments set forth herein, rather, these embodiments are provided so that this disclosure will satisfy the statutory requirements and convey the scope of the disclosure to those skilled in the art.

Among others, the subject matter of the disclosure can be embodied in whole or in part as a system, as one or more methods, or as one or more devices. Embodiments can take the form of a hardware implemented embodiment, a software implemented embodiment, or an embodiment combining software and hardware aspects. For example, in some embodiments, one or more of the operations, functions, processes, or methods disclosed and/or described herein can be implemented by one or more suitable processing elements (such as a processor, co-processor, microprocessor, Central Processing Unit, Graphics Processing Unit, Tensor Processing Unit, Quantum Processing Unit, controller, or a combination thereof, as non-limiting examples) that is part of a client device, server, network element, remote platform (such as a Software as a Service (Saas) platform), an “in the cloud” service, or other form of computing or data processing system, device, or platform.

The processing element or elements can be programmed with a set of executable instructions (e.g. software instructions), where the instructions can be stored on (or in) one or more suitable non-transitory computer-readable data storage elements, one or more suitable non-transitory computer-readable media, or both. In an embodiment, the set of instructions can be conveyed to a user through a transfer of instructions or an application that executes a set of instructions (such as over a network, e.g., the Internet). In an embodiment, a set of instructions or an application can be utilized by an end-user through access to a SaaS platform or a service provided through such a platform.

In an embodiment, the systems and methods disclosed herein can provide services through a SaaS or multi-tenant platform. The platform provides access to multiple entities, each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods, features, or functions disclosed herein.

In an embodiment, one or more of the operations, functions, processes, features, or methods disclosed herein can be implemented by a specialized form of hardware, such as a programmable gate array, application specific integrated circuit (ASIC), or the like. An embodiment of the disclosure can be implemented in the form of an application, a sub-routine that is part of a larger application, a “plug-in,” an extension to the functionality of a data processing system or platform, or other suitable form. This description is, therefore, not to be taken in a limiting sense.

It should be understood that the present invention as described herein can be implemented in a form of control logic using computer software in a modular or integrated manner. Based on the disclosure and teachings provided herein, a person of ordinary skill in the art will know and appreciate other techniques to implement an embodiment of the disclosure using hardware or a combination of hardware and software.

Any of the software components, processes or functions described in this application can be implemented as software code to be executed by a processor using any suitable computer language such as at least one of Python, Java, Javascript, C, C++, C #(“C Sharp”), Type Script, Java Script, Platform Client Application Programming Interface (API) Script, or Perl using procedural, functional, object-oriented, or other techniques. The software code can be stored as a series of instructions, or commands in (or on) a non-transitory computer-readable medium, such as a random-access memory (RAM), a read only memory (ROM), a magnetic medium such as a hard-drive, a jump drive, an optical medium such as a CD-ROM, or a combination thereof. In this context, a non-transitory computer-readable medium is almost any medium suitable for the storage of data or an instruction set aside from a transitory waveform. Any such computer readable medium can reside on or within a single computational apparatus and can be present on or within different computational apparatuses within a system or network.

According to one example implementation, the term processing element or processor, as used herein, can be a central processing unit (CPU), or conceptualized as a CPU (such as a virtual machine). In this example implementation, the CPU or a device in which the CPU is incorporated can be at least one of coupled, connected, or in communication with one or more peripheral devices, such as the user display device. In another example implementation, the processing element or processor can be incorporated into a mobile computing device, such as a smartphone or tablet computer.

The non-transitory computer-readable storage medium referred to herein can include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium can include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. In some embodiments, one or more of the blocks, or stages or steps may not necessarily need to be performed in the order presented or may not necessarily need to be performed.

The computer-executable program instructions described herein can be loaded onto a special purpose computer, a processor, or other programmable data processing apparatus to produce a specific example of a machine, such that the instructions executed by the computer, processor, or other programmable data processing apparatus create means for implementing one or more of the functions, operations, processes, or methods described herein. These computer program instructions can also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims when they have structural elements, functional elements, or both that do not differ from the literal language of the claims, or if they include structural elements, functional elements, or both with insubstantial differences from the literal language of the claims.

The use of the terms “a,” “an,” “the,” and similar referents in the specification and in the following claims are to be construed to cover both the singular and the plural, unless otherwise indicated herein or clearly contradicted by context. The singular portends the plural, where practicable. The terms “having,” “including,” “containing,” and similar referents in the specification and in the claims are to be construed as open-ended terms (e.g. meaning “including, but not limited to,”) unless otherwise noted. All methods described herein can be performed in any suitable order unless otherwise indicated herein or clearly contradicted by context. The use of all examples, or exemplary language (e.g. “such as”) provided herein, is intended merely to better illuminate embodiments of the disclosure and do not pose a limitation to the scope of the invention unless otherwise claimed. No language in the specification should be construed as indicating any non-claimed element as essential to each embodiment of the present invention.

The words “receiving,” “generating,” “extracting,” “determining,” “calculating,” and other forms thereof are intended to be open ended in that an item or items following any one of these words is not meant to be an exhaustive listing of such item or items or meant to be limited to only the listed item or items. The term “or” is used inclusively to refer to items in the alternative and in combination.

Different arrangements of the components depicted in the drawings or described above, as well as components and steps not shown or described are possible. Similarly, some features and sub-combinations are useful and can be employed without reference to other features and sub-combinations. Embodiments of the invention have been described for illustrative and not restrictive purposes, and alternative embodiments will become apparent to readers of this patent. Accordingly, the present invention is not limited to the embodiments described herein or depicted in the drawings, and various embodiments and modifications can be made without departing from the scope of the claims. The disclosed embodiments are merely exemplary of the disclosure, which can be embodied in various forms.

What is claimed is:

1. A computer-implemented method for performing a contract-based transaction of a specified number of assets represented in a digital form, at least a portion of the method being performed by a computing device comprising at least one processor, the method comprising:
receiving, at the computing device and from a contract originator user, information describing:
commitments for a contract, wherein the commitments comprise at least a transfer of the specified number of assets represented in the digital form;
conditions for the contract; and
an additional participant of the contract;
saving, in a computer-readable medium and to a contract proposal data structure, information describing:
contract data comprising a start date, a memo field configured to store miscellaneous information and metadata, a contract type, a universally unique transaction reference, and a retry interval for retrying in a non-success scenario;
a list of participants by public cryptographic key; and
a commitment group comprising an expiration date and one or more commitments, each commitment comprising:
an amount;
at least one sender key corresponding to at least one respective participant; and
at least one respective recipient key corresponding to at least one respective participant; and
electronically sending the contract proposal data structure to the additional participant of the contract, wherein the contract proposal data structure is encrypted using public key cryptography.

2. The computer-implemented method of claim 1, further comprising:
receiving an electronic proposal acknowledgment from the additional participant of the contract, wherein the electronic proposal acknowledgment indicates the additional participant of the contract confirms receipt of the contract proposal data structure.

3. The computer-implemented method of claim 1, further comprising:
saving, in the computer-readable medium and to a contract request data structure, the information describing the commitments for the contract; the conditions for the contract; and
the additional participant of the contract;
encrypting the contract request data structure using public key cryptography; and
electronically sending, to the additional participant of the contract, the contract request data structure.

4. The computer-implemented method of claim 1, further comprising receiving, from the additional participant of the contract, an updated contract request data structure.

5. The computer-implemented method of claim 1, further comprising:
receiving an electronic signature of the contract originator user;
saving, in the computer-readable medium and to a contract signatories data structure, the information describing the commitments for the contract; the conditions for the contract;
and the additional participant of the contract;
saving the electronic signature of the contract originator user to the contract signatories data structure; and
electronically sending, to the additional participant of the contract, the contract signatories data structure.

6. The computer-implemented method of claim 1, further comprising:
receiving, from the additional participant of the contract, an updated contract signatories data structure, wherein the updated contract signatories data structure comprises an electronic signature of an additional participant user and is encrypted using public key cryptography.

7. The computer-implemented method of claim 1, further comprising:
electronically sending, to a transaction validator, an updated contract signatories data structure.

8. The computer-implemented method of claim 1, wherein the specified number of assets represented in a digital form comprise an asset based on a distributed ledger, an asset based on a centralized ledger, or both.

9. The computer-implemented method of claim 1, wherein the information in the contract proposal data structure further describes a listing of all participants to the contract, and further comprising displaying, on a user display device, at least one participant in the listing of all participants to the contract.

10. The computer-implemented method of claim 1, further comprising:
sending, to the contract originator, an electronic proposal acknowledgment, wherein the electronic proposal acknowledgment confirms receipt of the contract proposal data structure.

11. The computer-implemented method of claim 1, further comprising:
receiving, at another computing device and from the contract originator, the contract proposal data structure;
decrypting the contract proposal data structure; and
displaying, on a user display device, information in the contract proposal data structure, wherein the information in the contract proposal data structure describes the commitments for a contract and the conditions for the contract.

12. The computer-implemented method of claim 1, further comprising:
receiving, via a user interface device and from a user who is an additional participant of the contract, an instruction to send an updated contract request data structure;
encrypting the updated contract request data structure using public key cryptography; and
electronically sending, to the contract originator, the updated contract request data structure.

13. The computer-implemented method of claim 1, further comprising:
receiving, at another computing device and from the contract originator, a contract signatories data structure, wherein the contract signatories data structure is encrypted using public key cryptography and comprises an electronic signature of the contract originator user;
decrypting the contract signatories data structure; and
displaying, on a user display device, information in the contract signatories data structure.

14. The computer-implemented method of claim 1, further comprising:
receiving, from a user who is an additional participant of the contract, an instruction to send an updated contract signatories data structure;
updating, in response to the instruction to send the updated contract signatories data structure, the contract signatories data structure with an electronic signature of the user who is the additional participant;
encrypting the updated contract signatories data structure using public key cryptography; and
electronically sending, to the contract originator, the updated contract signatories data structure.

15. The computer-implemented method of claim 1, further comprising:
determining that a condition requiring an absence of unlawful activity is met, wherein meeting the condition requiring the absence of the unlawful activity is a condition precedent to exchanging the specified number of assets represented in the digital form identified in the contract.

16. The computer-implemented method of claim 1, further comprising:
receiving, at another computing device and from the contract originator, the contract proposal data structure; and
displaying, on a user display device, information in the contract proposal data structure, wherein the information in the contract proposal data structure describes:
the commitments for the contract, including transfer of the specified number of assets represented in the digital form; and
the conditions for the contract.

17. The computer-implemented method of claim 16, further comprising decrypting the contract proposal data structure.

18. The computer-implemented method of claim 16, further comprising:
receiving, via a user interface device and from a user who is an additional participant to the contract, an instruction to reject the contract described by the information in the contract proposal data structure;
receiving, via the user interface device and from the user who is an additional participant to the contract, an electronic signature of the user who is an additional participant to the contract; and
sending, to the contract originator, an electronic message including information describing a rejection of the contract and the electronic signature of the user who is an additional participant to the contract.

19. A system for performing a contract-based transaction of a specified number of assets represented in a digital form, the system comprising:
at least one processor; and
at least one computer-readable medium storing instructions that, when executed by the at least one processor, cause the processor to:
receive, from a contract originator user, information describing:
commitments for a contract, wherein the commitments comprise at least a transfer of the specified number of assets represented in the digital form;
conditions for the contract; and
an additional participant of the contract;
save, in a computer-readable medium and to a contract proposal data structure, information describing:
contract data comprising a start date, a memo field configured to store miscellaneous information and metadata, a contract type, a universally unique transaction reference, and a retry interval for retrying in a non-success scenario;
a list of participants by public cryptographic key; and
a commitment group comprising an expiration date and one or more commitments, each commitment comprising:
an amount;
at least one sender key corresponding to at least one respective participant; and
at least one respective recipient key corresponding to at least one respective participant; and
electronically send the contract proposal data structure to the additional participant of the contract, wherein the contract proposal data structure is encrypted using public key cryptography.

20. A non-transitory computer-readable medium storing instructions that, when executed by at least one processor of a computing device, cause the computing device to perform a contract-based transaction of a specified number of assets represented in a digital form, the instructions comprising:
instructions to receive, from a contract originator user, information describing:
commitments for a contract, wherein the commitments comprise at least a transfer of the specified number of assets represented in the digital form;
conditions for the contract; and
an additional participant of the contract;
instructions to save, in a computer-readable medium and to a contract proposal data structure, information describing:
contract data comprising a start date, a memo field configured to store miscellaneous information and metadata, a contract type, a universally unique transaction reference, and a retry interval for retrying in a non-success scenario;
a list of participants by public cryptographic key; and
a commitment group comprising an expiration date and one or more commitments, each commitment comprising:
an amount;
at least one sender key corresponding to at least one respective participant; and
at least one respective recipient key corresponding to at least one respective participant; and
instructions to electronically send the contract proposal data structure to the additional participant of the contract, wherein the contract proposal data structure is encrypted using public key cryptography.
